(19) United States
(12) Patent Application Publication
(10) Pub. No.: US 2022/0358354 A1
(43) Pub. Date: Nov. 10, 2022

(54) ARCHITECTURE DESIGN FOR ENSEMBLE BINARY NEURAL NETWORK (EBNN) INFERENCE ENGINE ON SINGLE-LEVEL MEMORY CELL ARRAYS

(71) Applicant: SanDisk Technologies LLC, Addison, TX (US)

(72) Inventors: Tung Thanh Hoang, San Jose, CA (US); Wen Ma, Sunnyvale, CA (US); Martin Lueker-Boden, Fremont, CA (US)

(73) Assignee: SanDisk Technologies LLC, Addison, TX (US)

(21) Appl. No.: 17/307,584

(22) Filed: May 4, 2021

(51) Int. Cl. G06N 3/063; G06N 3/04; G06N 3/08; G06N 20/20; G06F 7/523

(52) U.S. Cl. CPC G06N 3/0635; G06N 3/0454; G06N 3/08; G06N 20/20; G06F 7/523

(57) ABSTRACT

To improve efficiencies for inferencing operations of neural networks, ensemble neural networks are used for compute-in-memory inferencing. In an ensemble neural network, the layers of a neural network are replaced by an ensemble of multiple smaller neural network generated from subsets of the same training data as would be used for the layers of the full neural network. Although the individual smaller network layers are “weak classifiers” that will be less accurate than the full neural network, by combining their outputs, such as in majority voting or averaging, the ensembles can have accuracies approaching that of the full neural network. Ensemble neural networks for compute-in-memory operations can have their efficiency further improved by implementations based binary memory cells, such as by binary neural networks using binary valued MRAM memory cells. The size of an ensemble can be increased or decreased to optimize the system according to error requirements.

### BACKGROUND

Artificial neural networks are finding increasing usage in artificial intelligence and machine learning applications. In an artificial neural network, a set of inputs is propagated through one or more intermediate, or hidden, layers to generate an output. The layers connecting the input to the output are connected by sets of weights that are generated in a training or learning phase by determining a set of a mathematical manipulations to turn the input into the output, moving through the layers calculating, the probability of each output. Once the weights are established, they can be used in the inference phase to determine the output from a set of inputs. Although such neural networks can provide highly accurate results, they are extremely computationally intensive, and the data transfers involved in reading the weights connecting the different layers out of memory and transferring these weights into the processing units of a processing unit can be quite intensive.

### BRIEF DESCRIPTION OF THE DRAWING

Like-numbered elements refer to common components in the different figures.

FIG. 1 is a block diagram of one embodiment of a memory system connected to a host.

FIG. 2 is a block diagram of one embodiment of a Front End Processor Circuit. In some embodiments, the Front End Processor Circuit is part of a Controller.

FIG. 3 is a block diagram of one embodiment of a Back End Processor Circuit. In some embodiments, the Back End Processor Circuit is part of a Controller.

FIG. 4 is a block diagram of one embodiment of a memory package.

FIG. 5 is a block diagram of one embodiment of a memory die.

FIGS. 6A and 6B illustrate an example of control circuits coupled to a memory structure through wafer-to-wafer bonding.

FIG. 7A depicts one embodiment of a portion of a memory array that forms a cross-point architecture in an oblique view.

FIGS. 7B and 7C respectively present side and top views of the cross-point structure in FIG. 7A.

FIG. 7D depicts an embodiment of a portion of a two level memory array that forms a cross-point architecture in an oblique view.

FIG. 8 illustrates a simple example of a convolutional neural network (CNN).

FIG. 9 illustrates a simple example of fully connected layers in an artificial neural network.

FIG. 10A is a flowchart describing one embodiment of a process for training a neural network to generate a set of weights.

FIG. 10B is a flowchart describing one embodiment of a process for inference using a neural network.

FIG. 11 is a schematic representation of a convolution operation in a convolutional neural network.

FIG. 12 is a schematic representation of the use of matrix multiplication in a fully connected layer of a neural network.

FIG. 13 is a block diagram of a high-level architecture of a compute in memory Deep Neural Networks (DNN) inference engine.

FIG. 14 illustrates the concept of an ensemble neural network.

FIGS. 15 and 16 respectively illustrate a bagging and a boosting approach to ensemble neural networks.

FIGS. 17-19 present several architectural embodiments for an ensemble binary neural network.

FIG. 20 is a high level flowchart for an embodiment of a control flow for the embodiments of FIGS. 17-19.

FIGS. 21-23 provide more detail on embodiments of the arrays for the ensemble as single bit MRAM arrays to realize binary valued vector matrix multiplication on a single level MRAM array.

FIG. 24 is a flowchart for an embodiment of performing an inference operation based on the structures illustrated in FIGS. 21-23.

FIG. 25 is a flowchart of an embodiment for optimizing power consumption during inferencing operations by utilizing ensemble binary neural networks that apply adaptive power control.

FIG. 26 is a flowchart of an embodiment for reinforcing ensemble binary neural network accuracy by adding binary neural networks to the ensemble.

### DETAILED DESCRIPTION

Inferencing operations in neural networks can be very time and energy intensive. One approach to efficiently implement inferencing is through use of non-volatile memory arrays in a compute-in-memory approach that stores weight values for layers of the neural network in the non-volatile memory cells of a memory device, with inputs values for the layers applied as voltage levels to the memory arrays. For example, an in-array matrix multiplication between a layer's weights and inputs can be performed by applying the input values for the layer as bias voltage on word lines, with the resultant currents on bit lines corresponding to the product of the weight stored in a corresponding memory cell and the input applied to the word line. As this operation can be applied to all of the bit lines of an array concurrently, this provides a highly efficient inferencing operation.

Although a compute-in-memory approach can be highly efficient compared to other methods, given that neural networks, such as deep neural networks (DNNs), can have very large numbers of layers each of very large number of weight values, inferencing can still be power and time intensive even for a compute-in-memory approach. To further improve efficiencies, the following introduces the use of ensemble neural networks for compute-in-memory inferencing. In an ensemble neural network, the layers of a neural network are replaced by an ensemble of multiple smaller neural networks generated from subsets of the same training data as would be used for the layers of the full neural network. Although the individual smaller network layers are “weak classifiers” that will be less accurate than the full neural network, by combining their outputs, such as in majority voting or averaging, the ensembles can have accuracies approaching that of the full neural network. The use of ensemble neural networks for compute-in-memory operations can have their efficiency further improved by implementations based binary memory cells, such as by binary neural networks (BNNs) using binary valued MRAM memory cells.

In other aspects, embodiments for ensemble neural networks can be further optimized by changing the number of neural networks in an ensemble. For example, if the amount of error of the ensemble is less than an allowed amount of error, the number of arrays used in the ensemble can be reduced. Conversely, if the amount error of an ensemble exceeds a maximum allowable amount of error, additional binary neural networks can be added to the ensemble.

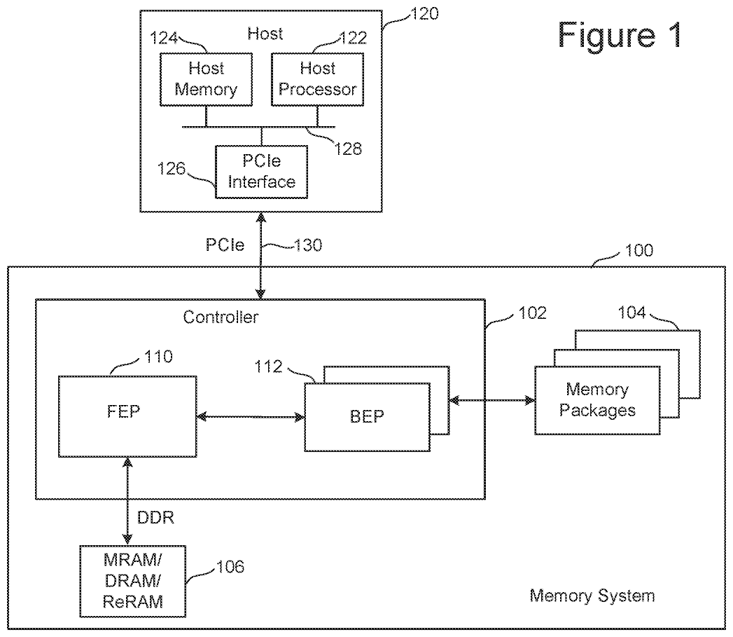

FIG. 1 is a block diagram of one embodiment of a memory system 100 connected to a host 120. Memory system 100 can implement the technology presented herein for ensemble binary neural network inferencing. Many different types of memory systems can be used with the technology proposed herein. Example memory systems include solid state drives (“SSDs”), memory cards including dual in-line memories (DIMMs) for DRAM replacement, and embedded memory devices; however, other types of memory systems can also be used.

Memory system 100 of FIG. 1 comprises a controller 102, non-volatile memory 104 for storing data, and local memory (e.g., DRAM/ReRAM) 106. Controller 102 comprises a Front End Processor (FEP) circuit 110 and one or more Back End Processor (BEP) circuits 112. In one embodiment FEP circuit 110 is implemented on an Application Specific Integrated Circuit (ASIC). In one embodiment, each BEP circuit 112 is implemented on a separate ASIC. In other embodiments, a unified controller ASIC can combine both the front end and back end functions. The ASICs for each of the BEP circuits 112 and the FEP circuit 110 are implemented on the same semiconductor such that the controller 102 is manufactured as a System on a Chip (“SoC”). FEP circuit 110 and BEP circuit 112 both include their own processors. In one embodiment, FEP circuit 110 and BEP circuit 112 work as a master slave configuration where the FEP circuit 110 is the master and each BEP circuit 112 is a slave. For example, FEP circuit 110 implements a Flash Translation Layer (FTL) or Media Management Layer (MML) that performs memory management (e.g., garbage collection, wear leveling, etc.), logical to physical address translation, communication with the host, management of DRAM (local volatile memory) and management of the overall operation of the SSD (or other non-volatile storage system). The BEP circuit 112 manages memory operations in the memory packages/die at the request of FEP circuit 110. For example, the BEP circuit 112 can carry out the read, erase, and programming processes. Additionally, the BEP circuit 112 can perform buffer management, set specific voltage levels required by the FEP circuit 110, perform error correction (ECC), control the Toggle Mode interfaces to the memory packages, etc. In one embodiment, each BEP circuit 112 is responsible for its own set of memory packages.

In one embodiment, non-volatile memory 104 comprises a plurality of memory packages. Each memory package includes one or more memory die. Therefore, controller 102 is connected to one or more non-volatile memory die. In one embodiment, each memory die in the memory packages 104 utilize NAND flash memory (including two dimensional NAND flash memory and/or three dimensional NAND flash memory). In other embodiments, the memory package can include other types of memory, such as storage class memory (SCM) based on resistive random access memory (such as ReRAM, MRAM, FeRAM or RRAM) or a phase change memory (PCM). In another embodiment, the BEP or FEP is included on the memory die.

Controller 102 communicates with host 120 via an interface 130 that implements a protocol such as, for example, NVM Express (NVMe) over PCI Express (PCIe) or using JEDEC standard Double Data. Rate (DDR) or Low-Power Double Data. Rate (LPDDR) interface such as DDR5 or LPDDR5. For working with memory system 100, host 120 includes a host processor 122, host memory 124, and a PCIe interface 126 connected along bus 128. Host memory 124 is the host's physical memory, and can be DRAM, SRAM, non-volatile memory, or another type of storage. Host 120 is external to and separate from memory system 100. In one embodiment, memory system 100 is embedded in host 120.

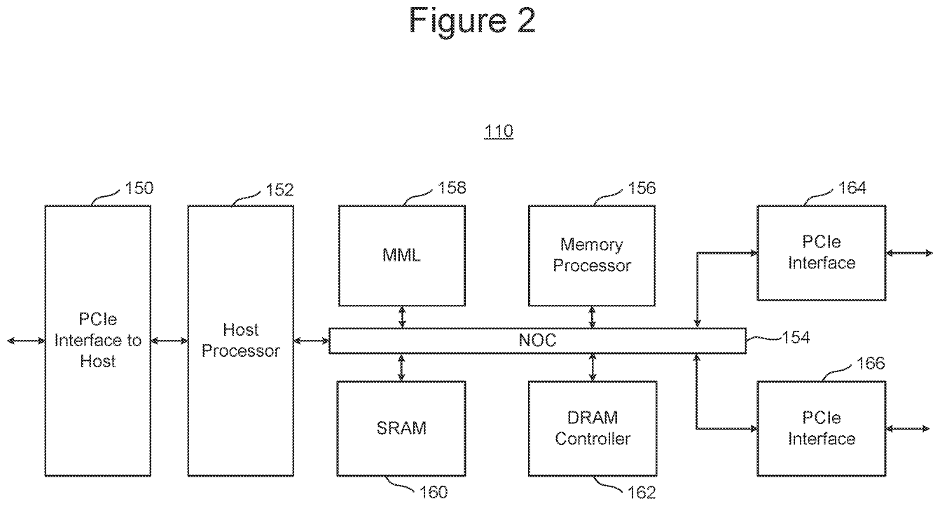

FIG. 2 is a block diagram of one embodiment of FEP circuit 110. FIG. 2 shows a PCIe interface 150 to communicate with host 120 and a host processor 152 in communication with that PCIe interface. The host processor 152 can be any type of processor known in the art that is suitable for the implementation. Host processor 152 is in communication with a network-on-chip (NOC) 154. A NOC is a communication subsystem on an integrated circuit, typically between cores in a SoC. NOCs can span synchronous and asynchronous clock domains or use unclocked asynchronous logic. NOC technology applies networking theory and methods to on-chip communications and brings notable improvements over conventional bus and crossbar interconnections. NOC improves the scalability of SoCs and the power efficiency of complex SoCs compared to other designs. The wires and the links of the NOC are shared by many signals. A high level of parallelism is achieved because all links in the NOC can operate simultaneously on different data packets. Therefore, as the complexity of integrated subsystems keep growing, a NOC provides enhanced performance (such as throughput) and scalability in comparison with previous communication architectures (e.g., dedicated point-to-point signal wires, shared buses, or segmented buses with bridges). Connected to and in communication with NOC 154 is the memory processor 156, SRAM 160 and a DRAM controller 162. The DRAM controller 162 is used to operate and communicate with the DRAM (e.g., DRAM 106). SRAM 160 is local RAM memory used by memory processor 156. Memory processor 156 is used to run the FEP circuit and perform the various memory operations. Also, in communication with the NOC are two PCIe Interfaces 164 and 166. In the embodiment of FIG. 2, the SSD controller will include two BEP circuits 112; therefore, there are two PCIe Interfaces 164/166. Each PCIe Interface communicates with one of the BEP circuits 112. In other embodiments, there can be more or less than two BEP circuits 112; therefore, there can be more than two PCIe Interfaces.

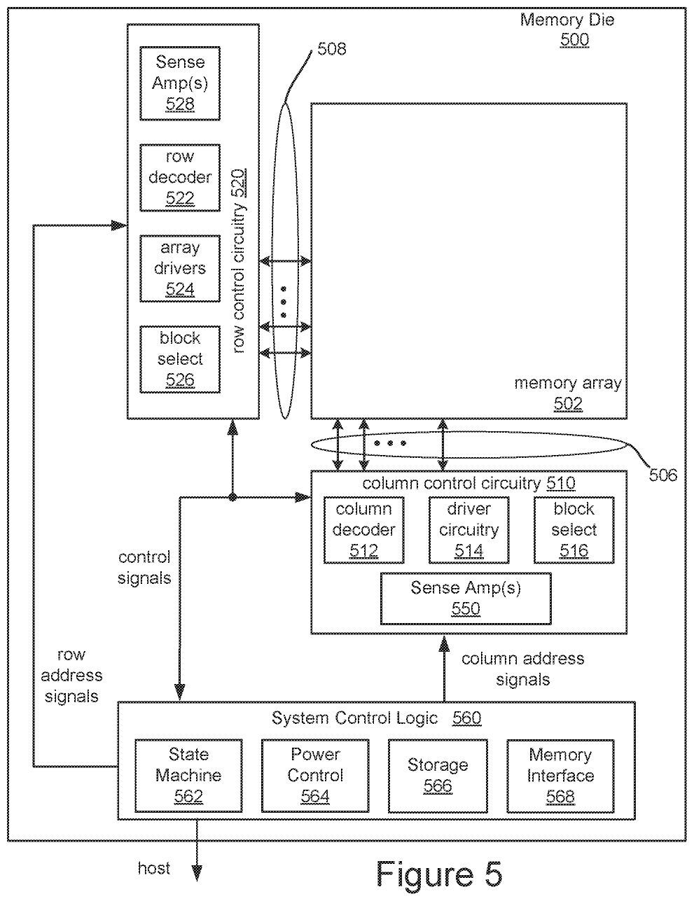

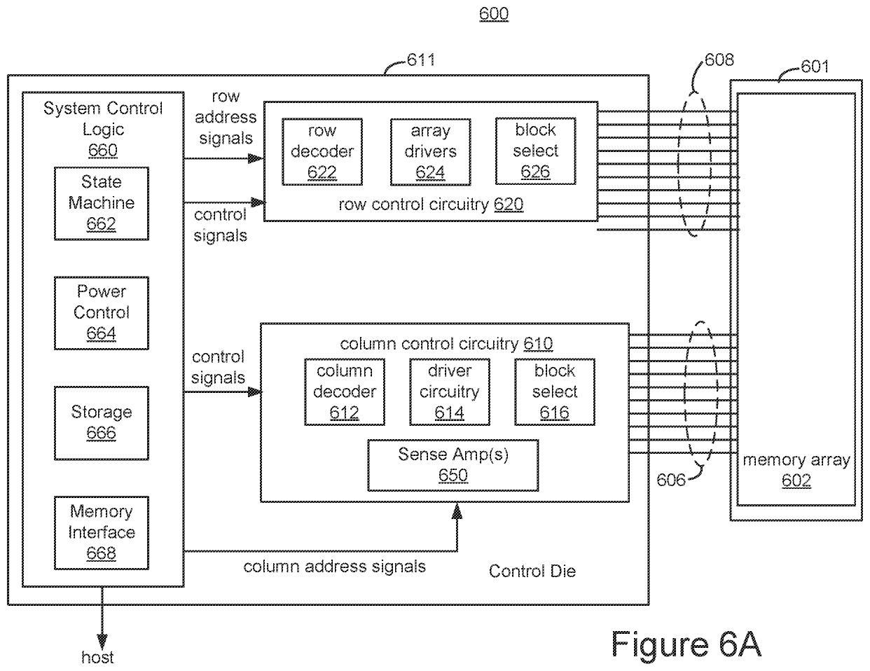

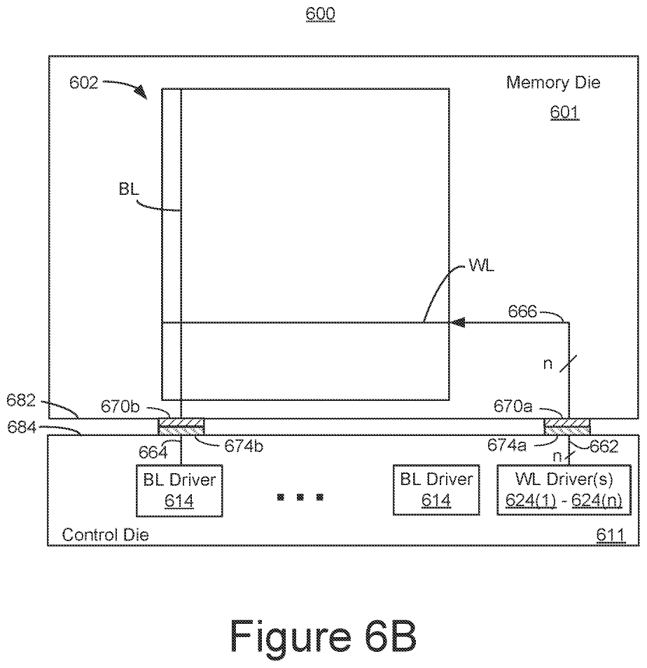

FEP circuit 110 can also include a Flash Translation Layer (FTL) or, more generally, a Media Management Layer (MML) 158 that performs memory management (e.g., garbage collection, wear leveling, load balancing, etc.), logical to physical address translation, communication with the host, management of DRAM (local volatile memory) and management of the overall operation of the SSD or other non-volatile storage system. The media management layer MML 158 may be integrated as part of the memory management that may handle memory errors and interfacing with the host. In particular, MML may be a module in the FEP circuit 110 and may be responsible for the internals of memory management. In particular, the MML 158 may include an algorithm in the memory device firmware which translates writes from the host into writes to the memory structure (e.g., 502/602 of FIGS. 5 and 6 below) of a die. The MML 158 may be needed because: 1) the memory may have limited endurance; 2) the memory structure may only be written in multiples of pages; and/or 3) the memory structure may not be written unless it is erased as a block. The MML 158 understands these potential limitations of the memory structure which may not be visible to the host. Accordingly, the MML 158 attempts to translate the writes from host into writes into the memory structure.

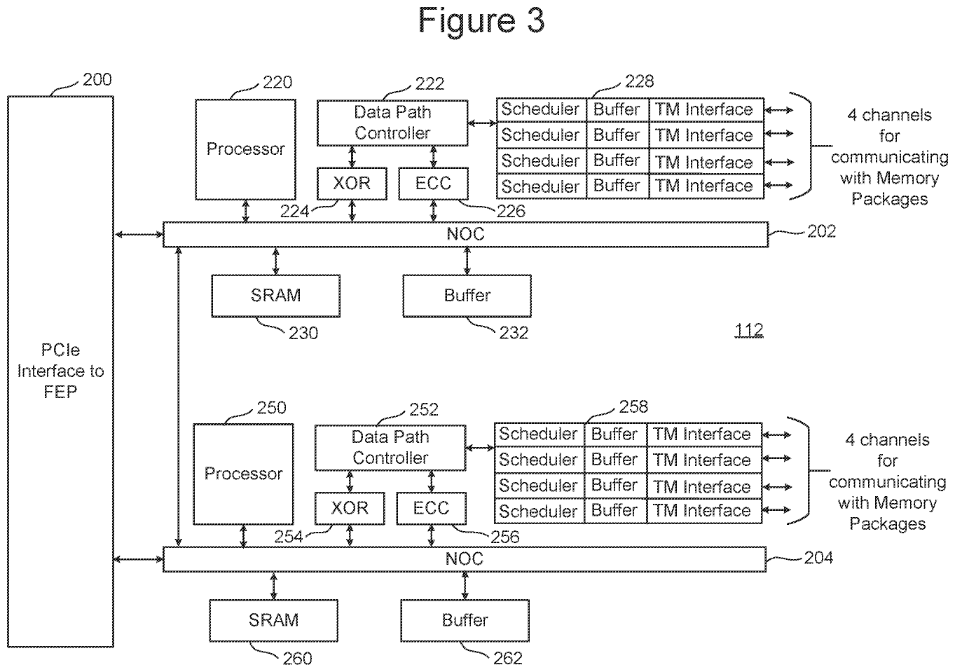

FIG. 3 is a block diagram of one embodiment of the BEP circuit 112. FIG. 3 shows a PCIe Interface 200 for communicating with the FEP circuit 110 (e.g., communicating with one of PCIe Interfaces 164 and 166 of FIG. 2). PCIe Interface 200 is in communication with two NOCs 202 and 204. In one embodiment the two NOCs can be combined into one large NOC. Each NOC (202/204) is connected to SRAM (230/260), a buffer (232/262), processor (220/250), and a data path controller (222/252) via an XOR engine (224/254) and an ECC engine (226/256). The ECC engines 226/256 are used to perform error correction, as known in the art. The XOR engines 224/254 are used to XOR the data so that data can be combined and stored in a manner that can be recovered in case there is a programming error. Data path controller 222 is connected to an interface module for communicating via four channels with memory packages. Thus, the top NOC 202 is associated with an interface 228 for four channels for communicating with memory packages and the bottom NOC 204 is associated with an interface 258 for four additional channels for communicating with memory packages. Each interface 228/258 includes four Toggle Mode interfaces (TM Interface), four buffers and four schedulers. There is one scheduler, buffer, and TM Interface for each of the channels. The processor can be any standard processor known in the art. The data path controllers 222/252 can be a processor, FPGA, microprocessor, or other type of controller. The XOR engines 224/254 and ECC engines 226/256 are dedicated hardware circuits, known as hardware accelerators. In other embodiments, the XOR engines 224/254 and ECC engines 226/256 can be implemented in software. The scheduler, buffer, and TM Interfaces are hardware circuits.

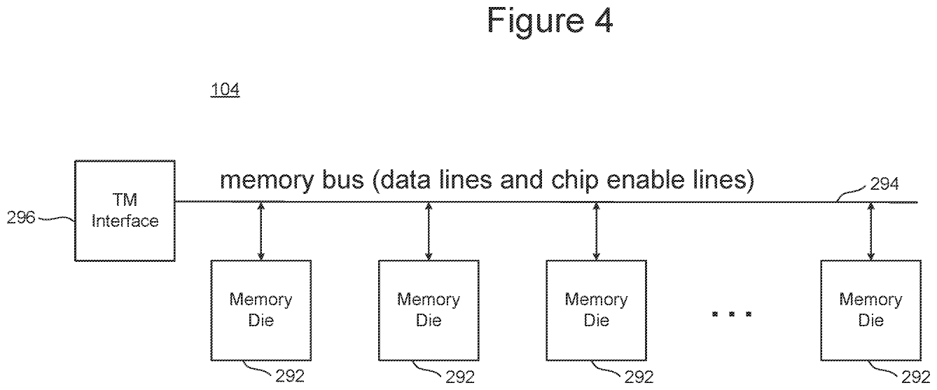

FIG. 4 is a block diagram of one embodiment of a memory package 104 that includes a plurality of memory die 292 connected to a memory bus (data lines and chip enable lines) 294. The memory bus 294 connects to a Toggle Mode Interface 296 for communicating with the TM Interface of a BEP circuit 112 (see e.g., FIG. 3). In some embodiments, the memory package can include a small controller connected to the memory bus and the TM Interface. The memory package can have one or more memory die. In one embodiment, each memory package includes eight or 16 memory die; however, other numbers of memory die can also be implemented. In another embodiment, the Toggle Interface is instead JEDEC standard DDR or LPDDR with or without variations such as relaxed time-sets or smaller page size. The technology described herein is not limited to any particular number of memory die.

FIG. 5 is a block diagram that depicts one example of a memory die 500 that can implement the technology described herein. Memory die 500, which can correspond to one of the memory die 292 of FIG. 4, includes a memory array 502 that can include any of memory cells described in the following. The array terminal lines of memory array 502 include the various layer(s) of word lines organized as rows, and the various layer(s) of bit lines organized as columns. However, other orientations can also be implemented. Memory die 500 includes row control circuitry 520, whose outputs 508 are connected to respective word lines of the memory array 502. Row control circuitry 520 receives a group of M row address signals and one or more various control signals from System Control Logic circuit 560, and typically may include such circuits as row decoders 522, array terminal drivers 524, and block select circuitry 526 for both reading and writing operations. Row control circuitry 520 may also include read/write circuitry. In an embodiment, row control circuitry 520 has sense amplifiers 528, which each contain circuitry for sensing a condition (e.g., voltage) of a word line of the memory array 502. In an embodiment, by sensing a word line voltage, a condition of a memory cell in a cross-point array is determined. Memory die 500 also includes column control circuitry 510 whose input/outputs 506 are connected to respective bit lines of the memory array 502. Although only single block is shown for array 502, a memory die can include multiple arrays or “tiles” that can be individually accessed. Column control circuitry 510 receives a group of N column address signals and one or more various control signals from System Control Logic 560, and typically may include such circuits as column decoders 512, array terminal receivers or drivers 514, block select circuitry 516, as well as read/write circuitry, and I/O multiplexers.

System control logic 560 receives data and commands from a host and provides output data and status to the host. In other embodiments, system control logic 560 receives data and commands from a separate controller circuit and provides output data to that controller circuit, with the controller circuit communicating with the host. In some embodiments, the system control logic 560 can include a state machine 562 that provides die-level control of memory operations. In one embodiment, the state machine 562 is programmable by software. In other embodiments, the state machine 562 does not use software and is completely implemented in hardware (e.g., electrical circuits). In another embodiment, the state machine 562 is replaced by a micro-controller or microprocessor, either on or off the memory chip. The system control logic 560 can also include a power control module 564 controls the power and voltages supplied to the rows and columns of the memory 502 during memory operations and may include charge pumps and regulator circuit for creating regulating voltages. System control logic 560 includes storage 566, which may be used to store parameters for operating the memory array 502.

Commands and data are transferred between the controller 102 and the memory die 500 via memory controller interface 568 (also referred to as a “communication interface”). Memory controller interface 568 is an electrical interface for communicating with memory controller 102. Examples of memory controller interface 568 include a Toggle Mode Interface and an Open NAND Flash Interface (ONFI). Other I/O interfaces can also be used. For example, memory controller interface 568 may implement a Toggle Mode Interface that connects to the Toggle Mode interfaces of memory interface 228/258 for memory controller 102. In one embodiment, memory controller interface 568 includes a set of input and/or output (I/O) pins that connect to the controller 102.

In some embodiments, all of the elements of memory die 500, including the system control logic 560, can be formed as part of a single die. In other embodiments, some or all of the system control logic 560 can be formed on a different die.

For purposes of this document, the phrase “one or more control circuits” can include a controller, a state machine, a micro-controller and/or other control circuitry as represented by the system control logic 560, or other analogous circuits that are used to control non-volatile memory.

In one embodiment, memory structure 502 comprises a three dimensional memory array of non-volatile memory cells in which multiple memory levels are formed above a single substrate, such as a wafer. The memory structure may comprise any type of non-volatile memory that are monolithically formed in one or more physical levels of memory cells having an active area disposed above a silicon (or other type of) substrate. In one example, the non-volatile memory cells comprise vertical NAND strings with charge-trapping.

In another embodiment, memory structure 502 comprises a two dimensional memory array of non-volatile memory cells. In one example, the non-volatile memory cells are NAND flash memory cells utilizing floating gates. Other types of memory cells (e.g., NOR-type flash memory) can also be used.

The exact type of memory array architecture or memory cell included in memory structure 502 is not limited to the examples above. Many different types of memory array architectures or memory technologies can be used to form memory structure 326. No particular non-volatile memory technology is required for purposes of the new claimed embodiments proposed herein. Other examples of suitable technologies for memory cells of the memory structure 502 include ReRAM memories (resistive random access memories), magnetoresistive memory (e.g., MRAM, Spin Transfer Torque MRAM, Spin Orbit Torque MRAM), FeRAM, phase change memory (e.g., PCM), and the like. Examples of suitable technologies for memory cell architectures of the memory structure 502 include two dimensional arrays, three dimensional arrays, cross-point arrays, stacked two dimensional arrays, vertical bit line arrays, and the like.

One example of a ReRAM cross-point memory includes reversible resistance-switching elements arranged in cross-point arrays accessed by X lines and Y lines (e.g., word lines and bit lines). In another embodiment, the memory cells may include conductive bridge memory elements. A conductive bridge memory element may also be referred to as a programmable metallization cell. A conductive bridge memory element may be used as a state change element based on the physical relocation of ions within a solid electrolyte. In some cases, a conductive bridge memory element may include two solid metal electrodes, one relatively inert (e.g., tungsten) and the other electrochemically active (e.g., silver or copper), with a thin film of the solid electrolyte between the two electrodes. As temperature increases, the mobility of the ions also increases causing the programming threshold for the conductive bridge memory cell to decrease. Thus, the conductive bridge memory element may have a wide range of programming thresholds over temperature.

Another example is magnetoresistive random access memory (MRAM) that stores data by magnetic storage elements. The elements are formed from two ferromagnetic layers, each of which can hold a magnetization, separated by a thin insulating layer. One of the two layers is a permanent magnet set to a particular polarity; the other layer's magnetization can be changed to match that of an external field to store memory. A memory device is built from a grid of such memory cells. In one embodiment for programming, each memory cell lies between a pair of write lines arranged at right angles to each other, parallel to the cell, one above and one below the cell. When current is passed through them, an induced magnetic field is created. MRAM based memory embodiments will be discussed in more detail below.

Phase change memory (PCM) exploits the unique behavior of chalcogenide glass. One embodiment uses a GeTe—Sb2Te3 super lattice to achieve non-thermal phase changes by simply changing the co-ordination state of the Germanium atoms with a laser pulse (or light pulse from another source). Therefore, the doses of programming are laser pulses. The memory cells can be inhibited by blocking the memory cells from receiving the light. In other PCM embodiments, the memory cells are programmed by current pulses. Note that the use of “pulse” in this document does not require a square pulse but includes a (continuous or non-continuous) vibration or burst of sound, current, voltage, light, or other wave. These memory elements within the individual selectable memory cells, or bits, may include a further series element that is a selector, such as an ovonic threshold switch or metal insulator substrate.

A person of ordinary skill in the art will recognize that the technology described herein is not limited to a single specific memory structure, memory construction or material composition, but covers many relevant memory structures within the spirit and scope of the technology as described herein and as understood by one of ordinary skill in the art.

The elements of FIG. 5 can be grouped into two parts, the structure of memory structure 502 of the memory cells and the peripheral circuitry, including all of the other elements. An important characteristic of a memory circuit is its capacity, which can be increased by increasing the area of the memory die of memory system 500 that is given over to the memory structure 502; however, this reduces the area of the memory die available for the peripheral circuitry. This can place quite severe restrictions on these peripheral elements. For example, the need to fit sense amplifier circuits within the available area can be a significant restriction on sense amplifier design architectures. With respect to the system control logic 560, reduced availability of area can limit the available functionalities that can be implemented on-chip. Consequently, a basic trade-off in the design of a memory die for the memory system 500 is the amount of area to devote to the memory structure 502 and the amount of area to devote to the peripheral circuitry.

Another area in which the memory structure 502 and the peripheral circuitry are often at odds is in the processing involved in forming these regions, since these regions often involve differing processing technologies and the trade-off in having differing technologies on a single die. For example, when the memory structure 502 is NAND flash, this is an NMOS structure, while the peripheral circuitry is often CMOS based. For example, elements such sense amplifier circuits, charge pumps, logic elements in a state machine, and other peripheral circuitry in system control logic 560 often employ PMOS devices. Processing operations for manufacturing a CMOS die will differ in many aspects from the processing operations optimized for an NMOS flash NAND memory or other memory cell technologies.

To improve upon these limitations, embodiments described below can separate the elements of FIG. 5 onto separately formed dies that are then bonded together. More specifically, the memory structure 502 can be formed on one die and some or all of the peripheral circuitry elements, including one or more control circuits, can be formed on a separate die. For example, a memory die can be formed of just the memory elements, such as the array of memory cells of flash NAND memory, MRAM memory, PCM memory, ReRAM memory, or other memory type. Some or all of the peripheral circuitry, even including elements such as decoders and sense amplifiers, can then be moved on to a separate die. This allows each of the memory die to be optimized individually according to its technology. For example, a NAND memory die can be optimized for an NMOS based memory array structure, without worrying about the CMOS elements that have now been moved onto a separate peripheral circuitry die that can be optimized for CMOS processing. This allows more space for the peripheral elements, which can now incorporate additional capabilities that could not be readily incorporated were they restricted to the margins of the same die holding the memory cell array. The two die can then be bonded together in a bonded multi-die memory circuit, with the array on the one die connected to the periphery elements on the other memory circuit. Although the following will focus on a bonded memory circuit of one memory die and one peripheral circuitry die, other embodiments can use more die, such as two memory die and one peripheral circuitry die, for example.

FIGS. 6A and 6B show an alternative arrangement to that of FIG. 5, which may be implemented using wafer-to-wafer bonding to provide a bonded die pair for memory system 600. FIG. 6A shows an example of the peripheral circuitry, including control circuits, formed in a peripheral circuit or control die 611 coupled to memory structure 602 formed in memory die 601. As with 502 of FIG. 5, the memory die 601 can include multiple independently accessible arrays or “tiles”. Common components are labelled similarly to FIG. 5 (e.g., 502 is now 602, 510 is now 610, and so on). It can be seen that system control logic 660, row control circuitry 620, and column control circuitry 610 are located in control die 611. In some embodiments, all or a portion of the column control circuitry 610 and all or a portion of the row control circuitry 620 are located on the memory structure die 601. In some embodiments, some of the circuitry in the system control logic 660 is located on the on the memory structure die 601.

System control logic 660, row control circuitry 620, and column control circuitry 610 may be formed by a common process (e.g., CMOS process), so that adding elements and functionalities, such as ECC, more typically found on a memory controller 102 may require few or no additional process steps (i.e., the same process steps used to fabricate controller 102 may also be used to fabricate system control logic 660, row control circuitry 620, and column control circuitry 610). Thus, while moving such circuits from a die such as memory die 292 may reduce the number of steps needed to fabricate such a die, adding such circuits to a die such as control die 611 may not require any additional process steps.

FIG. 6A shows column control circuitry 610 on the control die 611 coupled to memory structure 602 on the memory structure die 601 through electrical paths 606. For example, electrical paths 606 may provide electrical connection between column decoder 612, driver circuitry 614, and block select 616 and bit lines of memory structure 602. Electrical paths may extend from column control circuitry 610 in control die 611 through pads on control die 611 that are bonded to corresponding pads of the memory structure die 601, which are connected to bit lines of memory structure 602. Each bit line of memory structure 602 may have a corresponding electrical path in electrical paths 606, including a pair of bond pads, which connects to column control circuitry 610. Similarly, row control circuitry 620, including row decoder 622, array drivers 624, block select 626, and sense amplifiers 628 are coupled to memory structure 602 through electrical paths 608. Each of electrical path 608 may correspond to a word line, dummy word line, or select gate line. Additional electrical paths may also be provided between control die 611 and memory die 601.

For purposes of this document, the phrase “control circuit” can include one or more of controller 102, system control logic 660, column control circuitry 610, row control circuitry 620, a micro-controller, a state machine, and/or other control circuitry, or other analogous circuits that are used to control non-volatile memory. The control circuit can include hardware only or a combination of hardware and software (including firmware). For example, a controller programmed by firmware to perform the functions described herein is one example of a control circuit. A control circuit can include a processor, FGA, ASIC, integrated circuit, or other type of circuit.

In the following discussion, the memory array 502/602 of FIGS. 5 and 6A will be discussed in the context of a cross-point architecture. In a cross-point architecture, a first set of conductive lines or wires, such as word lines, run in a first direction relative to the underlying substrate and a second set of conductive lines or wires, such a bit lines, run in a second relative to the underlying substrate. The memory cells are sited at the intersection of the word lines and bit lines. The memory cells at these cross-points can be formed according to any of a number of technologies, including those described above. The following discussion will mainly focus on embodiments based on a cross-point architecture using MRAM memory cells.

FIG. 6B is a block diagram showing more detail on the arrangement of one embodiment of the integrated memory assembly of bonded die pair 600. Memory die 601 contains a plane or array 602 of memory cells. The memory die 601 may have additional planes or arrays. One representative bit line (BL) and representative word line (WL) 666 is depicted for each plane or array 602. There may be thousands or tens of thousands of such bit lines per each plane or array 602. In one embodiment, an array or plane represents a groups of connected memory cells that share a common set of unbroken word lines and unbroken bit lines.

Control die 611 includes a number of bit line drivers 614. Each bit line driver 614 is connected to one bit line or may be connected to multiple bit lines in some embodiments. The control die 611 includes a number of word line drivers 624(1)-624(n). The word line drivers 660 are configured to provide voltages to word lines. In this example, there are “n” word lines per array or plane memory cells. If the memory operation is a program or read, one word line within the selected block is selected for the memory operation, in one embodiment. If the memory operation is an erase, all of the word lines within the selected block are selected for the erase, in one embodiment. The word line drivers 660 provide voltages to the word lines in memory die 601. As discussed above with respect to FIG. 6A, the control die 611 may also include charge pumps, voltage generators, and the like that are not represented in FIG. 6B, which may be used to provide voltages for the word line drivers 660 and/or the bit line drivers 614.

The memory die 601 has a number of bond pads 670a, 670b on a first major surface 682 of memory die 601. There may be “n” bond pads 670a, to receive voltages from a corresponding “n” word line drivers 624(1)-624(n). There may be one bond pad 670b for each bit line associated with array 602. The reference numeral 670 will be used to refer in general to bond pads on major surface 682.

In some embodiments, each data bit and each parity bit of a codeword are transferred through a different bond pad pair 670b, 674b. The bits of the codeword may be transferred in parallel over the bond pad pairs 670b, 674b. This provides for a very efficient data transfer relative to, for example, transferring data between the memory controller 102 and the integrated memory assembly 600. For example, the data bus between the memory controller 102 and the integrated memory assembly 600 may, for example, provide for eight, sixteen, or perhaps 32 bits to be transferred in parallel. However, the data bus between the memory controller 102 and the integrated memory assembly 600 is not limited to these examples.

The control die 611 has a number of bond pads 674a, 674b on a first major surface 684 of control die 611. There may be “n” bond pads 674a, to deliver voltages from a corresponding “n” word line drivers 624(1)-624(n) to memory die 601. There may be one bond pad 674b for each bit line associated with array 602. The reference numeral 674 will be used to refer in general to bond pads on major surface 682. Note that there may be bond pad pairs 670a/674a and bond pad pairs 670b/674b. In some embodiments, bond pads 670 and/or 674 are flip-chip bond pads.

In one embodiment, the pattern of bond pads 670 matches the pattern of bond pads 674. Bond pads 670 are bonded (e.g., flip chip bonded) to bond pads 674. Thus, the bond pads 670, 674 electrically and physically couple the memory die 601 to the control die 611. Also, the bond pads 670, 674 permit internal signal transfer between the memory die 601 and the control die 611. Thus, the memory die 601 and the control die 611 are bonded together with bond pads. Although FIG. 6A depicts one control die 611 bonded to one memory die 601, in another embodiment one control die 611 is bonded to multiple memory dies 601.

Herein, “internal signal transfer” means signal transfer between the control die 611 and the memory die 601. The internal signal transfer permits the circuitry on the control die 611 to control memory operations in the memory die 601. Therefore, the bond pads 670, 674 may be used for memory operation signal transfer. Herein, “memory operation signal transfer” refers to any signals that pertain to a memory operation in a memory die 601. A memory operation signal transfer could include, but is not limited to, providing a voltage, providing a current, receiving a voltage, receiving a current, sensing a voltage, and/or sensing a current.

The bond pads 670, 674 may be formed for example of copper, aluminum, and alloys thereof. There may be a liner between the bond pads 670, 674 and the major surfaces (682, 684). The liner may be formed for example of a titanium/titanium nitride stack. The bond pads 670, 674 and liner may be applied by vapor deposition and/or plating techniques. The bond pads and liners together may have a thickness of 720 nm, though this thickness may be larger or smaller in further embodiments.

Metal interconnects and/or vias may be used to electrically connect various elements in the dies to the bond pads 670, 674. Several conductive pathways, which may be implemented with metal interconnects and/or vias are depicted. For example, a sense amplifier may be electrically connected to bond pad 674b by pathway 664. Relative to FIG. 6A, the electrical paths 606 can correspond to pathway 664, bond pads 674b, and bond pads 670b. There may be thousands of such sense amplifiers, pathways, and bond pads. Note that the BL does not necessarily make direct connection to bond pad 670b. The word line drivers 660 may be electrically connected to bond pads 674a by pathways 662. Relative to FIG. 6A, the electrical paths 608 can correspond to the pathway 662, the bond pads 674a, and bond pads 670a. Note that pathways 662 may comprise a separate conductive pathway for each word line driver 624(1)-624(n). Likewise, a there may be a separate bond pad 674a for each word line driver 624(1)-624(n). The word lines in block 2 of the memory die 601 may be electrically connected to bond pads 670a by pathways 664. In FIG. 6B, there are “n” pathways 664, for a corresponding “n” word lines in a block. There may be separate pair of bond pads 670a, 674a for each pathway 664.

Relative to FIG. 5, the on-die control circuits of FIG. 6A can also include addition functionalities within its logic elements, both more general capabilities than are typically found in the memory controller 102 and some CPU capabilities, but also application specific features.

In the following, system control logic 560/660, column control circuitry 510/610, row control circuitry 520/620, and/or controller 102 (or equivalently functioned circuits), in combination with all or a subset of the other circuits depicted in FIG. 5 or on the control die 611 in FIG. 6A and similar elements in FIG. 5, can be considered part of the one or more control circuits that perform the functions described herein. The control circuits can include hardware only or a combination of hardware and software (including firmware). For example, a controller programmed by firmware to perform the functions described herein is one example of a control circuit. A control circuit can include a processor, FGA, ASIC, integrated circuit, or other type of circuit.

In the following discussion, the memory array 502/602 of FIGS. 5 and 6A will mainly be discussed in the context of a cross-point architecture, although much of the discussion can be applied more generally. In a cross-point architecture, a first set of conductive lines or wires, such as word lines, run in a first direction relative to the underlying substrate and a second set of conductive lines or wires, such a bit lines, run in a second relative to the underlying substrate. The memory cells are sited at the intersection of the word lines and bit lines. The memory cells at these cross-points can be formed according to any of a number of technologies, including those described above. The following discussion will mainly focus on embodiments based on a cross-point architecture using MRAM memory cells.

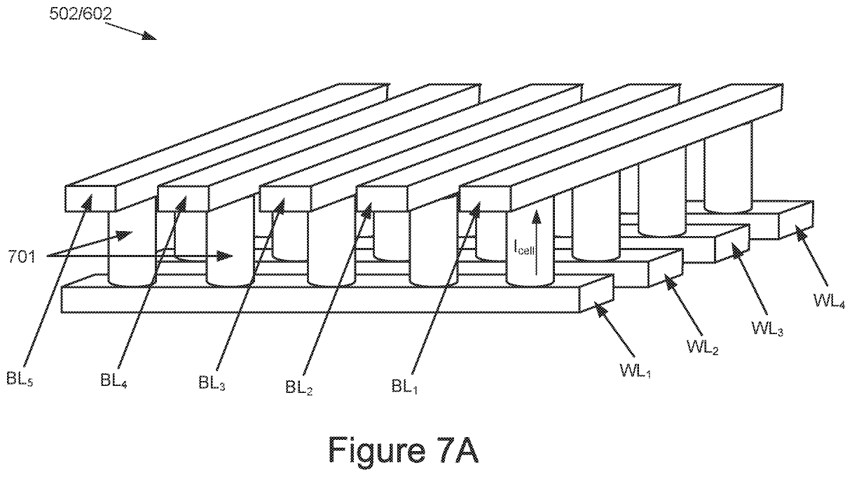

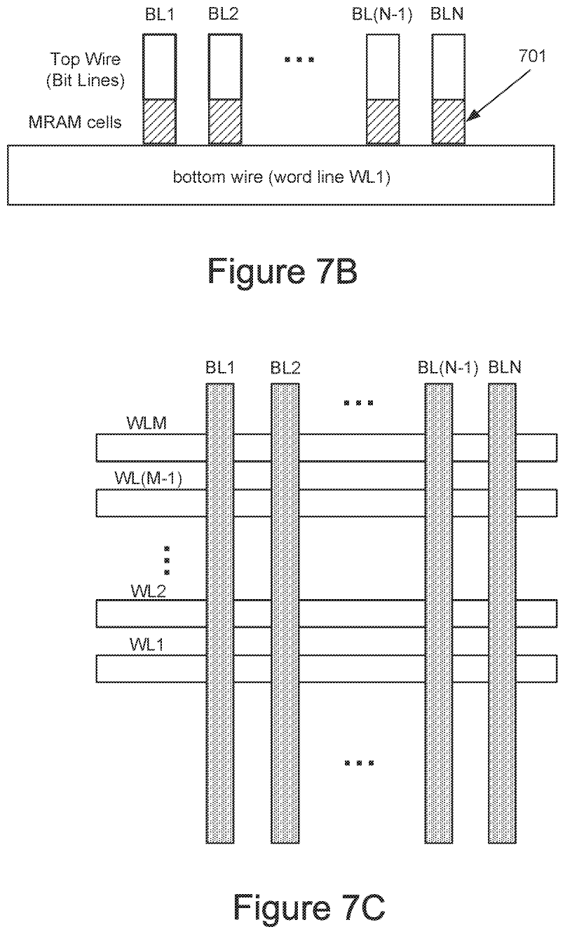

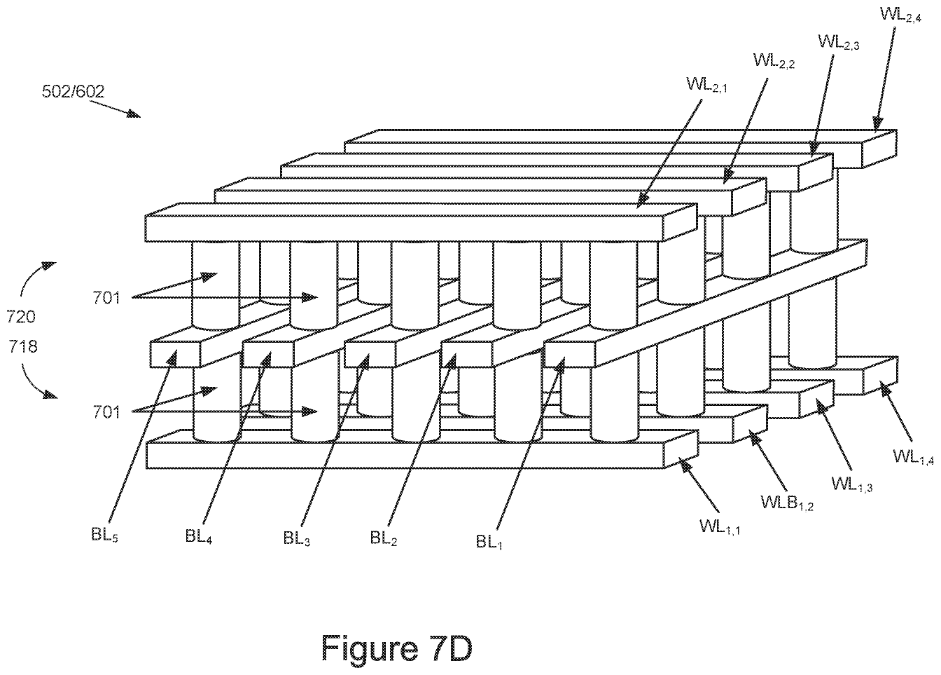

FIG. 7A depicts one embodiment of a portion of a memory array that forms a cross-point architecture in an oblique view. Memory array 502/602 of FIG. 7A is one example of an implementation for memory array 502 in FIG. 5 or 602 in FIG. 6A, where a memory die can include multiple such array structures. The bit lines BL₁-BL₅ are arranged in a first direction (represented as running into the page) relative to an underlying substrate (not shown) of the die and the word lines WL₁-WL₅ are arranged in a second direction perpendicular to the first direction. FIG. 7A is an example of a horizontal cross-point structure in which word lines WL₁-WL₅ and BL₁-BL₅ both run in a horizontal direction relative to the substrate, while the memory cells, two of which are indicated at 701, are oriented so that the current through a memory cell (such as shown at Lai) runs in the vertical direction. In a memory array with additional layers of memory cells, such as discussed below with respect to FIG. 7D, there would be corresponding additional layers of bit lines and word lines.

As depicted in FIG. 7A, memory array 502/602 includes a plurality of memory cells 701. The memory cells 701 may include re-writeable memory cells, such as can be implemented using ReRAM, MRAM, PCM, or other material with a programmable resistance. The following discussion will focus on MRAM memory cells, although much of the discussion can be applied more generally. The current in the memory cells of the first memory level is shown as flowing upward as indicated by arrow Lai, but current can flow in either direction, as is discussed in more detail in the following.

FIGS. 7B and 7C respectively present side and top views of the cross-point structure in FIG. 7A. The sideview of FIG. 7B shows one bottom wire, or word line, WL₁ and the top wires, or bit lines, BL₁-BLₙ. At the cross-point between each top wire and bottom wire is an MRAM memory cell 701, although PCM, ReRAM, or other technologies can be used. FIG. 7C is a top view illustrating the cross-point structure for M bottom wires WL₁-WL_{M} and N top wires BL₁-BL_{N}. In a binary embodiment, the MRAM cell at each cross-point can be programmed into one of at least two resistance states: high and low. More detail on embodiments for an MRAM memory cell design and techniques for their programming are given below.

The cross-point array of FIG. 7A illustrates an embodiment with one layer of word lines and bits lines, with the MRAM or other memory cells sited at the intersection of the two sets of conducting lines. To increase the storage density of a memory die, multiple layers of such memory cells and conductive lines can be formed. A 2-layer example is illustrated in FIG. 7D.

FIG. 7D depicts an embodiment of a portion of a two level memory array that forms a cross-point architecture in an oblique view. As in FIG. 7A, FIG. 7D shows a first layer 718 of memory cells 701 of an array 502/602 connected at the cross-points of the first layer of word lines WL_{1,1}-WL_{1,4} and bit lines BL₁-BL₅. A second layer of memory cells 720 is formed above the bit lines BL₁-BL₅ and between these bit lines and a second set of word lines WL_{2,1}-WL_{2,4}. Although FIG. 7D shows two layers, 718 and 720, of memory cells, the structure can be extended upward through additional alternating layers of word lines and bit lines. Depending on the embodiment, the word lines and bit lines of the array of FIG. 7D can be biased for read or program operations such that current in each layer flows from the word line layer to the bit line layer or the other way around. The two layers can be structured to have current flow in the same direction in each layer for a given operation or to have current flow in the opposite directions.

The use of a cross-point architecture allows for arrays with a small footprint and several such arrays can be formed on a single die. The memory cells formed at each cross-point can a resistive type of memory cell, where data values are encoded as different resistance levels. Depending on the embodiment, the memory cells can be binary valued, having either a low resistance state or a high resistance state, or multi-level cells (MLCs) that can have additional resistance intermediate to the low resistance state and high resistance state. The cross-point arrays described here can be used as the memory die 292 of FIG. 4, to replace local memory 106, or both. Resistive type memory cells can be formed according to many of the technologies mentioned above, such as ReRAM, FeRAM, PCM, or MRAM. The following discussion is presented mainly in the context of memory arrays using a cross-point architecture with binary valued MRAM memory cells, although much of the discussion is more generally applicable.

Turning now to types of data that can be stored in non-volatile memory devices, a particular example of the type of data of interest in the following discussion is the weights used is in artificial neural networks, such as convolutional neural networks or CNNs. The name “convolutional neural network” indicates that the network employs a mathematical operation called convolution, that is a specialized kind of linear operation. Convolutional networks are neural networks that use convolution in place of general matrix multiplication in at least one of their layers. A CNN is formed of an input and an output layer, with a number of intermediate hidden layers. The hidden layers of a CNN are typically a series of convolutional layers that “convolve” with a multiplication or other dot product.

Each neuron in a neural network computes an output value by applying a specific function to the input values coming from the receptive field in the previous layer. The function that is applied to the input values is determined by a vector of weights and a bias. Learning, in a neural network, progresses by making iterative adjustments to these biases and weights. The vector of weights and the bias are called filters and represent particular features of the input (e.g., a particular shape). A distinguishing feature of CNNs is that many neurons can share the same filter.

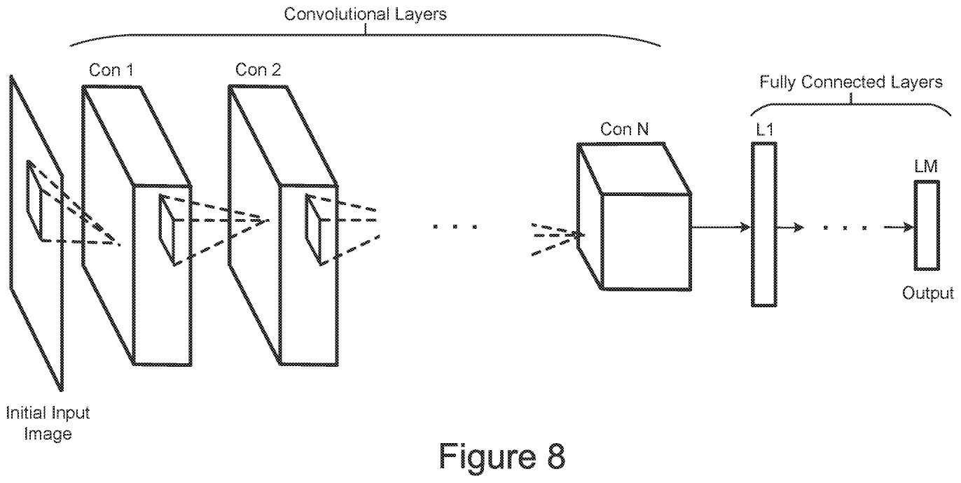

FIG. 8 is a schematic representation of an example of a CNN. FIG. 8 illustrates an initial input image of an array of pixel values, followed by a number of convolutional layers that are in turn followed by a number of fully connected layers, the last of which provides the output. Each neuron in the first convolutional layer (Con 1) takes as input data from an n×n pixel sub-region of the input image. The neuron's learned weights, which are collectively referred to as its convolution filter, determine the neuron's single-valued output in response to the input. In the convolutional layers, a neuron's filter is applied to the input image by sliding the input region along the image's x and y dimensions to generate the values of the convolutional layer. In practice, the equivalent convolution is normally implemented by statically identical copies of the neuron to different input regions. The process is repeated through each of the convolutional layers (Coni to Con N) using each layer's learned weights, after which it is propagated through the fully connected layers (L1 to LM) using their learned weights.

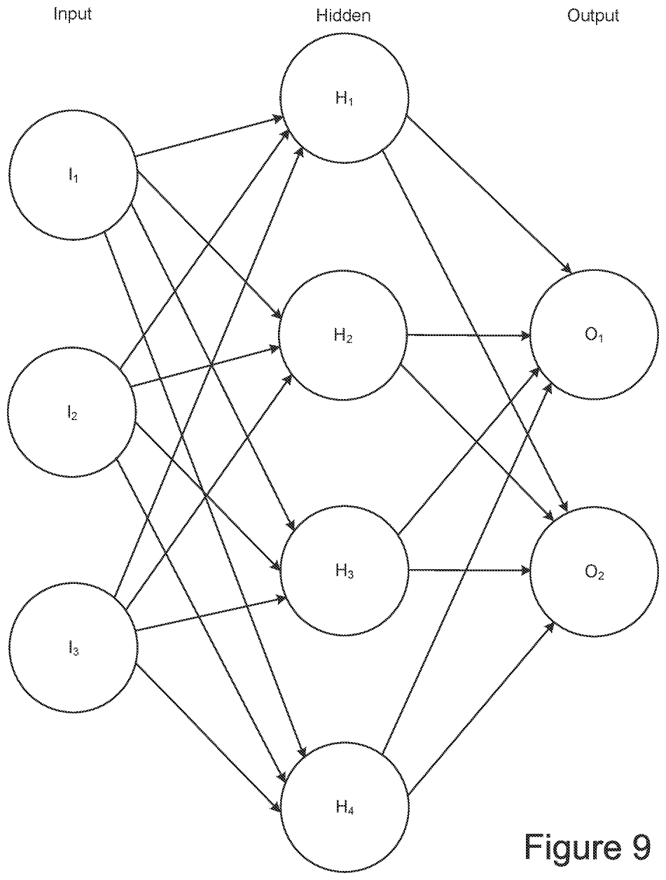

FIG. 9 represents several fully connected layers of a neural network in more detail. In FIG. 9, the shown three layers of the artificial neural network are represented as an interconnected group of nodes or artificial neurons, represented by the circles, and a set of connections from the output of one artificial neuron to the input of another. The example shows three input nodes (I₁, I₂, I₃) and two output nodes (O₁, O₂), with an intermediate layer of four hidden or intermediate nodes (H₁, H₂, H₃, H₄). The nodes, or artificial neurons/synapses, of the artificial neural network are implemented by logic elements of a host or other processing system as a mathematical function that receives one or more inputs and sums them to produce an output. Usually, each input is separately weighted and the sum is passed through the node's mathematical function to provide the node's output.

In common artificial neural network implementations, the signal at a connection between nodes (artificial neurons/synapses) is a real number, and the output of each artificial neuron is computed by some non-linear function of the sum of its inputs. Nodes and their connections typically have a weight that adjusts as a learning process proceeds. The weight increases or decreases the strength of the signal at a connection. Nodes may have a threshold such that the signal is only sent if the aggregate signal crosses that threshold. Typically, the nodes are aggregated into layers. Different layers may perform different kinds of transformations on their inputs. Signals travel from the first layer (the input layer) to the last layer (the output layer), possibly after traversing the layers multiple times. Although FIG. 8 shows only a single intermediate or hidden layer, a complex deep neural network (DNN) can have many such intermediate layers.

A supervised artificial neural network is “trained” by supplying inputs and then checking and correcting the outputs. For example, a neural network that is trained to recognize dog breeds will process a set of images and calculate the probability that the dog in an image is a certain breed. A user can review the results and select which probabilities the network should display (above a certain threshold, etc.) and return the proposed label. Each mathematical manipulation as such is considered a layer, and complex neural networks have many layers. Due to the depth provided by a large number of intermediate or hidden layers, neural networks can model complex non-linear relationships as they are trained.

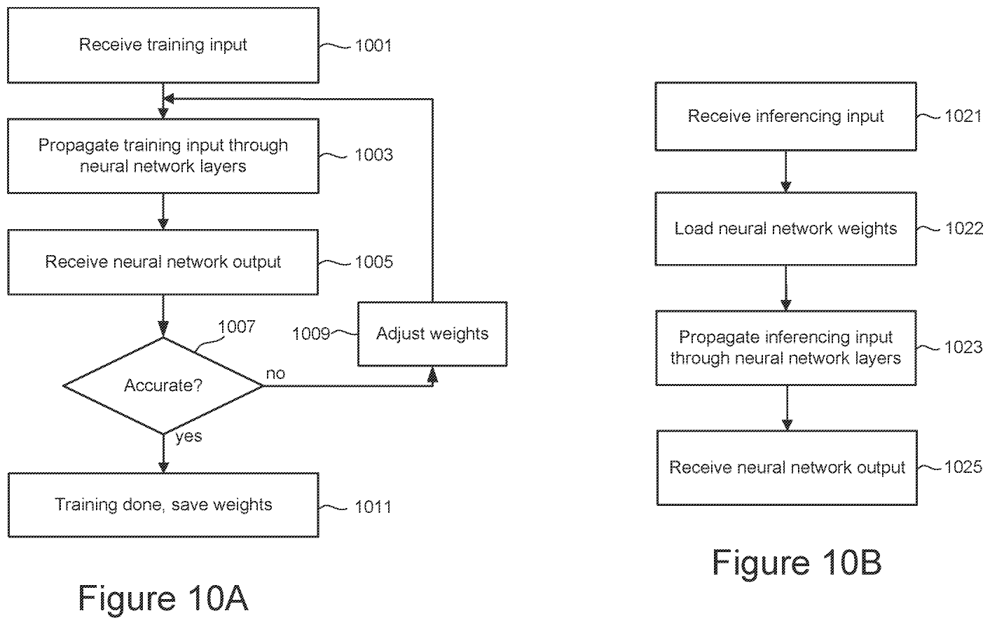

FIG. 10A is a flowchart describing one embodiment of a process for training a neural network to generate a set of weights. The training process is often performed in the cloud, allowing additional or more powerful processing to be accessed. At step 1001, the input, such as a set of images, is received (e.g., the image input in FIG. 8). At step 1003 the input is propagated through the layers connecting the input to the next layer (e.g., CON1 in FIG. 8) using the current filter, or set of weights. The neural network's output is then received at the next layer (e.g., CON2 in FIG. 8) in step 1005, so that the values received as output from one layer serve as the input to the next layer. The inputs from the first layer are propagated in this way through all of the intermediate or hidden layers until they reach the output. In the dog breed example of the preceding paragraph, the input would be the image data of a number of dogs, and the intermediate layers use the current weight values to calculate the probability that the dog in an image is a certain breed, with the proposed dog breed label returned at step 1005. A user can then review the results at step 1007 to select which probabilities the neural network should return and decide whether the current set of weights supply a sufficiently accurate labelling and, if so, the training is complete (step 1011). If the result is not sufficiently accurate, the neural network adjusts the weights at step 1009 based on the probabilities the user selected, followed by looping back to step 1003 to run the input data again with the adjusted weights. Once the neural network's set of weights have been determined, they can be used to “inference,” which is the process of using the determined weights to generate an output result from data input into the neural network. Once the weights are determined at step 1011, they can then be stored in non-volatile memory for later use, where the storage of these weights in non-volatile memory is discussed in further detail below.

FIG. 10B is a flowchart describing a process for the inference phase of supervised learning using a neural network to predict the “meaning” of the input data using an estimated accuracy. Depending on the case, the neural network may be inferenced both in the cloud and by an edge device's (e.g., smart phone, automobile process, hardware accelerator) processor. At step 1021, the input is received, such as the image of a dog in the example used above. If the previously determined weights are not present in the device running the neural network application, they are loaded at step 1022. For example, on a host processor executing the neural network, the weights could be read out of an SSD in which they are stored and loaded into RAM on the host device. At step 1023, the input data is then propagated through the neural network's layers. Step 1023 will be similar to step 1003 of FIG. 10B, but now using the weights established at the end of the training process at step 1011. After propagating the input through the intermediate layers, the output is then provided at step 1025.

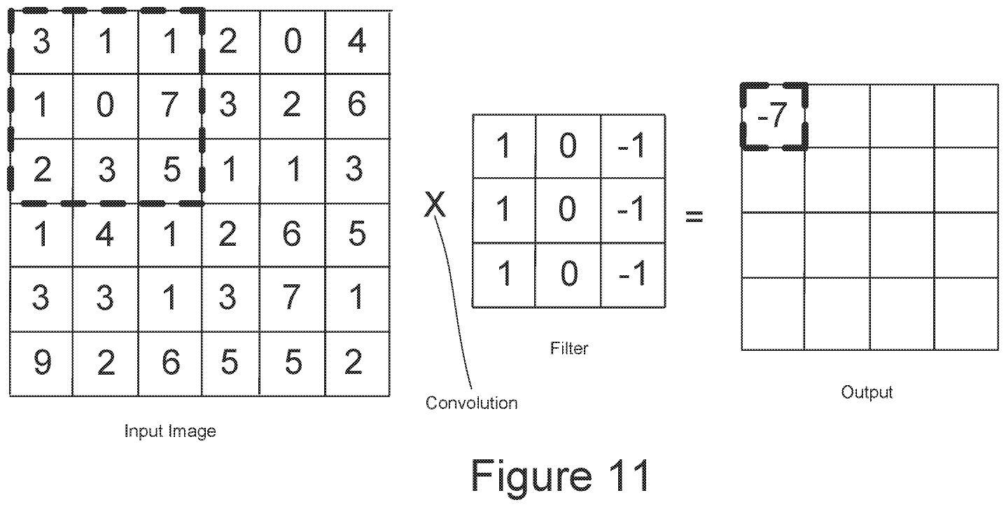

FIG. 11 is a schematic representation of a convolution operation between an input image and filter, or set of weights. In this example, the input image is a 6×6 array of pixel values and the filter is a 3×3 array of weights. The convolution operation is performed by a matrix multiplication of the 3×3 filter with 3×3 blocks of the input image. For example, the multiplication of the upper-left most 3×3 block of the image with the filter results in the top left value of the output matrix. The filter can then be slid across by one pixel on the image to generate the next entry of the output, and so on to generate a top row of 4 elements for the output. By repeating this by sliding the filter down a pixel at a time, the 4×4 output matrix is generated. Similar operations are performed for each of the layers. In a real CNN, the size of the data sets and the number of convolutions performed mean that extremely large numbers of such operations are performed involving very large amounts of data.

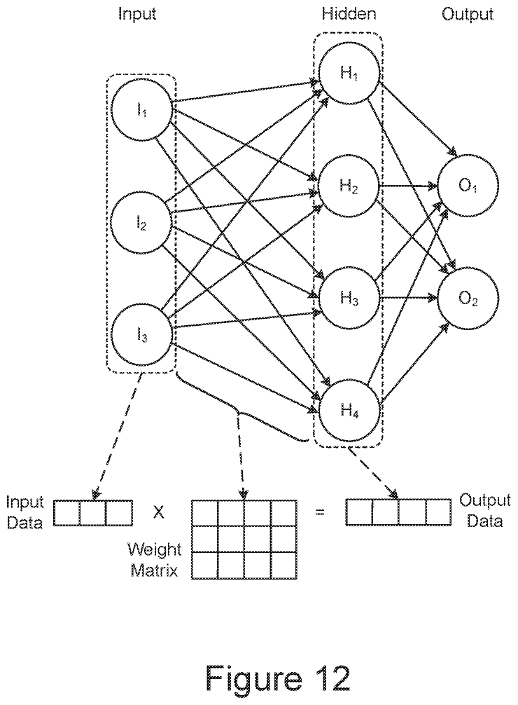

FIG. 12 is a schematic representation of the use of matrix multiplication in a fully connected layer of a neural network. Matrix multiplication, or MatMul, is a commonly used approach in both the training and inference phases for neural networks and is used in kernel methods for machine learning. FIG. 12 at the top is similar to FIG. 9, where only a single hidden layer is shown between the input layer and the output layer. The input data is represented as a vector of a length corresponding to the number of input nodes. The weights are represented in a weight matrix, where the number of columns corresponds to the number of intermediate nodes in the hidden layer and the number of rows corresponds to the number of input nodes. The output is determined by a matrix multiplication of the input vector and the weight matrix, where each element of the output vector is a dot product of the vector of the input data with a column of the weight matrix.

A common technique for executing the matrix multiplications is by use of a multiplier-accumulator (MAC, or MAC unit). However, this has a number of issues. Referring back to FIG. 10B, the inference phase loads the neural network weights at step 1022 before the matrix multiplications are performed by the propagation at step 1023. However, as the amount of data involved can be extremely large, use of a multiplier-accumulator for inferencing has several issues related to the loading of weights. One of these issues is high energy dissipation due to having to use large MAC arrays with the required bit-width. Another issue is high energy dissipation due to the limited size of MAC arrays, resulting in high data movement between logic and memory and an energy dissipation that can be much higher than used in the logic computations themselves.

To help avoid these limitations, the use of a multiplier-accumulator array can be replaced with other memory technologies. For example, the matrix multiplication can be computed within a memory array by leveraging the characteristics of NAND memory and MRAM memory or other Storage Class Memory (SCM), such as those based on ReRAM, PCM, or FeRAM based memory cells. This allows for the neural network inputs to be provided via read commands and the neural weights to be preloaded for inferencing. By use of in-memory computing, this can remove the need for logic to perform the matrix multiplication in the MAC array and the need to move data between the memory and the MAC array.

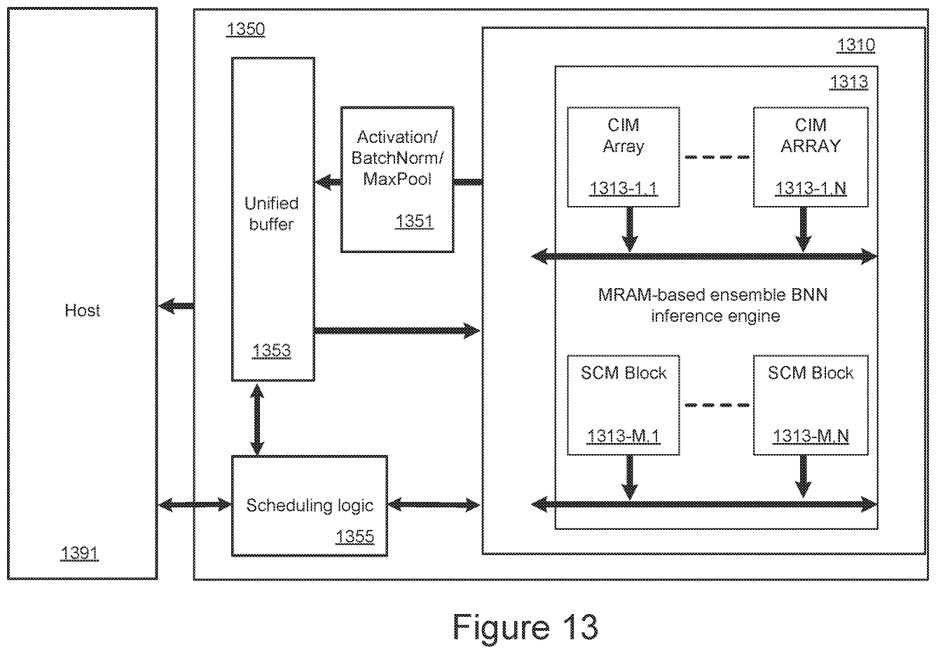

FIG. 13 is a block diagram of a high-level architecture of an embodiment for a compute in memory DNN inference engine that provides context for the follow discussion. In FIG. 13, a non-volatile memory device 1350 includes a memory die 1310 of multiple memory blocks 1313 represented as M rows and N columns of arrays, including a general SCM-based memory portion, of which two blocks 1313-(M,1) and 1313-(M,N) are shown, and a compute in-memory (CIM) DNN inference engine portion, of which two blocks 2213-(1,1) and 1313-(1,N) are shown. Each of the CIM blocks of memory die 1310 can be operated to compute in-memory the multiply and accumulate operations of a DNN as described below. The memory die 1310 of FIG. 13 only represents the memory blocks, but can also include additional peripheral/control elements of FIG. 5 or be the memory die of a bonded die pair as in FIG. 6A.

In addition to the one or more control circuits that generate the product values from the integrated circuit of memory die 1310, other elements on the memory device (such as on the controller 102) include a unified buffer 1353 that can buffer data being transferred from the host device 1391 to the memory die 1310 and also receive data from the memory die 1310 being transferred from to the host device 1391. For use in inferencing, neural network operations such as activation, batch normalization, and max pooling 1351 can be performed by processing on the controller for data from the memory die 1310 before it is passed on to the unified buffer 1353. Scheduling logic 1355 can oversee the inferencing operations.

In the embodiment of FIG. 13, the memory die 1310 is storage class memory, but in other embodiments can be NAND memory or based on other memory technologies. In the embodiment of FIG. 13, the memory die includes a number of SCM memory blocks or sub-arrays 1313-i,j, some that are configured to operate as a compute in-memory (CIM) DNN inference engine and others that can work as basic memory and can be employed, for examples, as buffers in a multiple layer neural network or a large neural network that cannot fit in a single memory device. The embodiment of FIG. 13 can be referred to as having inter-chip heterogenous functions. In alternate embodiments, an intra-chip heterogenous arrangement of multiple memory diescan be used, were some chips support DNN inference, while others are basic memory, or where the two variations can be combined.

A compute in memory approach to DNNs can have a number of advantages for machine learning applications operating in energy-limited systems. The weights are stationary stored in the SCM arrays 1313 of the DNN inference engine, thus eliminating unnecessary data movement from/to the host. The input data can be programmed by the host 1391 to access CIM arrays such as 1313-1,1 and 1313-1,N and computational logic can be replaced by memory cell access. The compute in memory DNN inference engine can be integrated as accelerators to support machine learning applications in the larger memory system or for a host device (e.g., 1391). Additionally, the structure is highly scalable with model size.

Although a compute in memory neural network architecture allows for relatively efficient computations, neural networks can have many layers each with large weight matrices, requiring vary large numbers of weight values to be stored. Consequently, although compute in memory systems can greatly increase the efficiency of neural network operations, their operation may still be time and energy intensive. One may to improve this situation is through use of an Ensemble Neural Network (ENN).

A neural network ensemble is a technique to combine multiple “weak classifiers” neural networks (simple neural networks trained with small datasets for short training time, and/or requiring simple hyper-parameter turning) in efficient way to achieve a final classified error close to, or even better than, a single “strong classifier” (deep/complex neural networks trained with large datasets for long training time, and/or require extremely hard hyper-parameter turning). The goal of a neural network ensemble is to reduce the variance of predictions of weak classifiers and reduce generalization error.

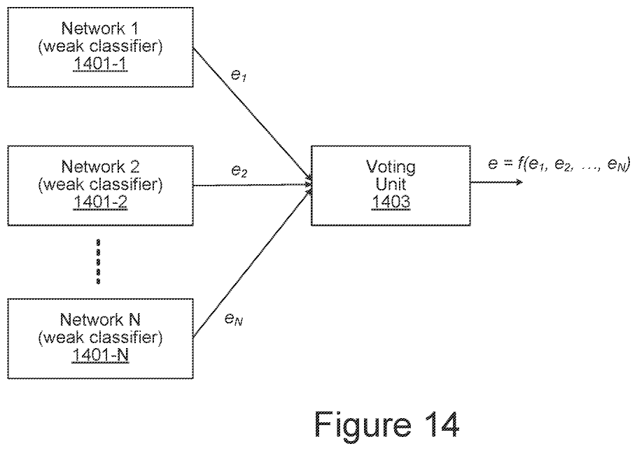

FIG. 14 illustrates the concept of an ensemble neural network. Multiple weak classifier networks (Network 1 1401-1, Network 2 1401-2, . . . , Network N 1401-N) each generate an output having a respective amount of error (e₁, e₂, . . . , e_{N}). The individual weak classifier outputs are intermediate output values that are then combined in the Combination 1403 processing circuitry to produce an output having an amount of error that is a function of the errors from the weak classifiers: e=ƒ(e₁, e₂, . . . , e_{N}).

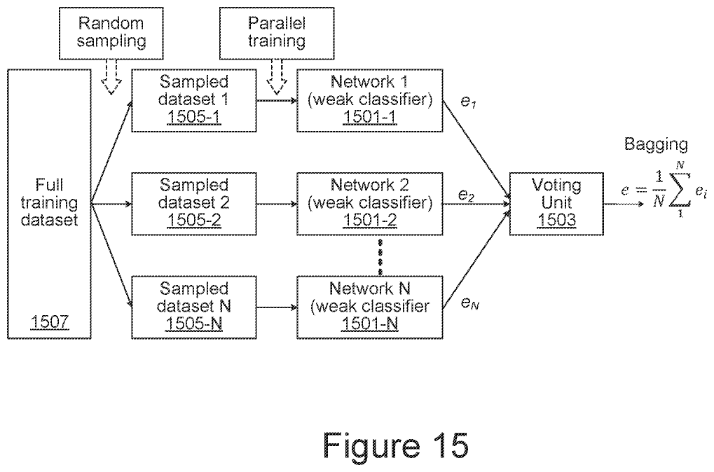

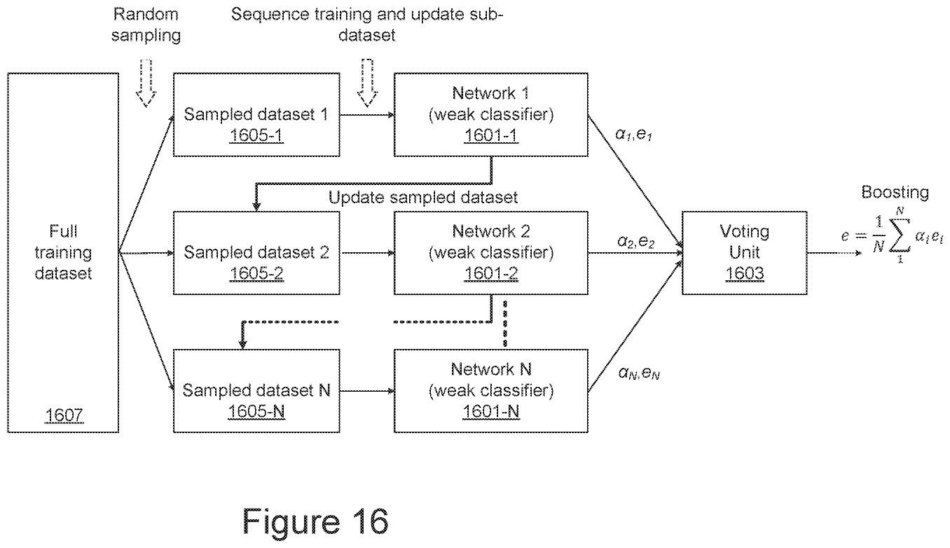

FIGS. 15 and 16 respectively illustrate a bagging and a boosting approach to ensemble neural networks. In the bagging (or bootstrap aggregating) approach, the weak classifier networks Network 1 1501-1, Network 2 1501-2, . . . , Network N 1501-N are considered as independent units and the comparison can use a voting unit 1503 using averaging voting techniques (e.g., weighted average, majority vote or normal average) to derive the final output. This results in an amount of error:

$$e = \frac{1}{N} {\sum }_{1}^{N} {e}_{i}$$

As illustrated in FIG. 15, during training through random sampling of the full data set 1507, N sampled data subsets 1505-i, i=1-N, are obtained. Each of the weak classifier networks Network 1 1501-1, Network 2 1502-2, . . . , Network N 1502-N are then trained on their corresponding data subset, where the training of the networks can be done in parallel. As each of the weak classifier networks can be trained in parallel on the reduced data set, training time can be reduced. The final error e is also reduced due to reducing variance of the individual errors eᵢ. Additionally, the bagging approach can handle overfitting well.

FIG. 16 illustrates the boosting approach, which considers the sequential dependency of classifiers in which each classifier can contribute a different weight to the final error. Each weak classifier networks 1601-i again uses a sampled data set 1605-i generated by random sampling to generate a subset of a full training data set 1607. In boosting, the networks are trained sequentially and with updating of the data subset, so that sampled data set 1607-(1+1) is updated to include more training data for the objects that have low accuracy when training with the network 1601-i. Also generated by the training procedure is an error value eᵢ and an error weight αᵢ, so that the final error from voting unit 1603 is:

$$e = \frac{1}{N} {\sum }_{1}^{N} {α}_{i} {e}_{i}$$

Relative to bagging, boosting has a longer training time due to sequentially training the classifiers and updating sample of data sets, but again reduces final error through reduced variance and bias. The scaling factors αᵢ can be stored in non-volatile registers of the memory system so that need not be accessed from the host, thereby improving both security and performance. For example, the αᵢ could in registers in the storage 566/666 of system control logic 560/660 or in registers in the controller 102 or in local memory 106, for example.

Compute-In-Memory (CIM) inference engines have been considered as promising approach that can achieve significant energy-delay improvement over the conventional digital implementations, but use multi-bit fixed-point computation to achieve high prediction accuracy (e.g., comparable to floating-point inference engine). Use of multi-bit storage class memory, such as multi-bit MRAM cells for CIM DNN, faces several challenges. One is the increased error due to noise caused by peripheral analog components (i.e., ADCs, DACs) and the non-linear characteristic of memory cells (i.e., multi-level cell). Such implementations can also have significant energy/delay/area costs of due to peripheral analog components (i.e., multibit ADC and DAC, or sense amplifiers). Additionally, multi-bit MRAM is often difficult to realize and display non-linearities.

To efficiently apply non-volatile memory device to compute in memory implementation of neural networks, the following presents embodiments for flexible and high-accuracy architectures of ensemble binary neural network (BNN) inference engines using only single-bit resistive memory cell arrays. The discussion here focusses on MRAM memory, but can also be applied to other technologies such as such as ReRAM, FeRAM, RRAM, or PCM. Binary neural networks use 1-bit activations (layer inputs) and 1-bit weight values, allowing for a highly efficient architecture to be realized in a 1-bit MRAM based compute-in-memory implementation. Such designs can have low energy/delay/area and memory cost due to requiring only 1-bit to encode activations and weights and MRAM is suitable for reliable single-bit memory cells. A binary implementation also allows for simple peripheral analog components, such as the use of single-bit sense amplifiers, and without use of a digital-to-analog converter (DAC) to control the word line voltage of the array. Although binary implementations may decrease inference accuracy for large data sets or for deep network structures, the use of an ensemble BNN inference engine can help overcome these limitations.

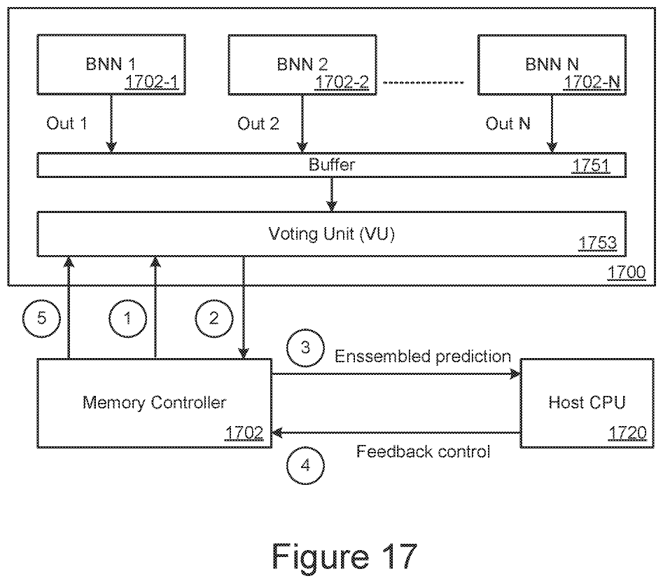

FIGS. 17-19 present several architectural embodiments for an ensemble binary neural network. The presented architecture of ensembles uses multiple single-bit MRAM-based BNN inference engines to improve prediction accuracy by using a voting unit (VU).

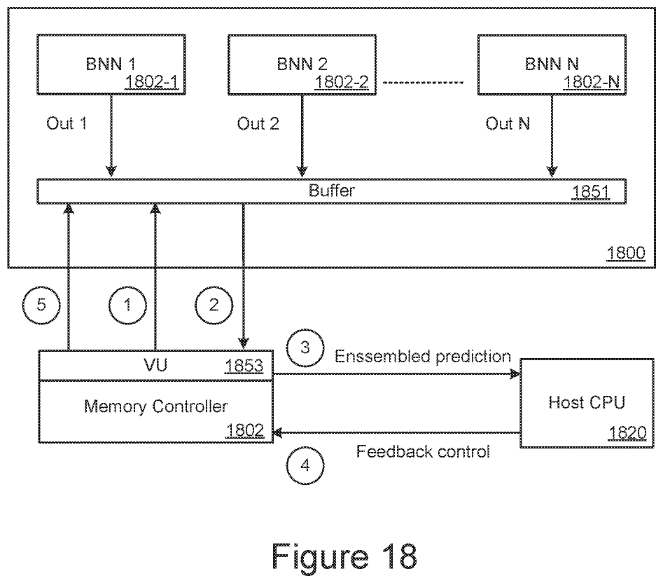

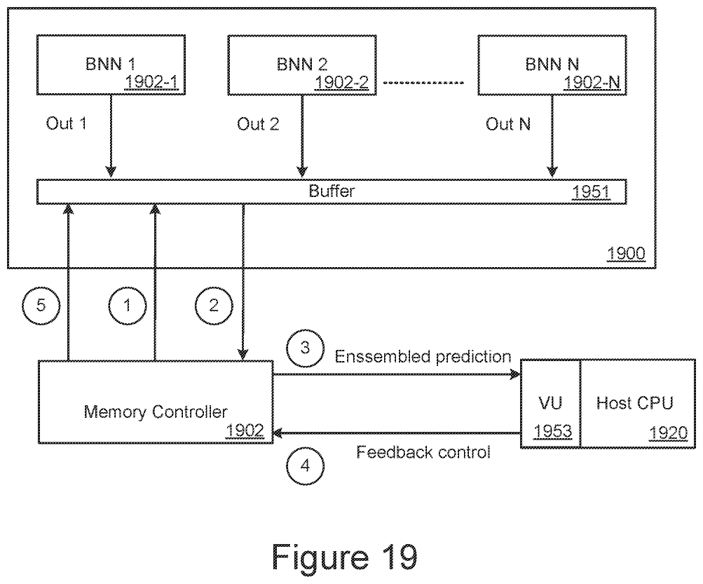

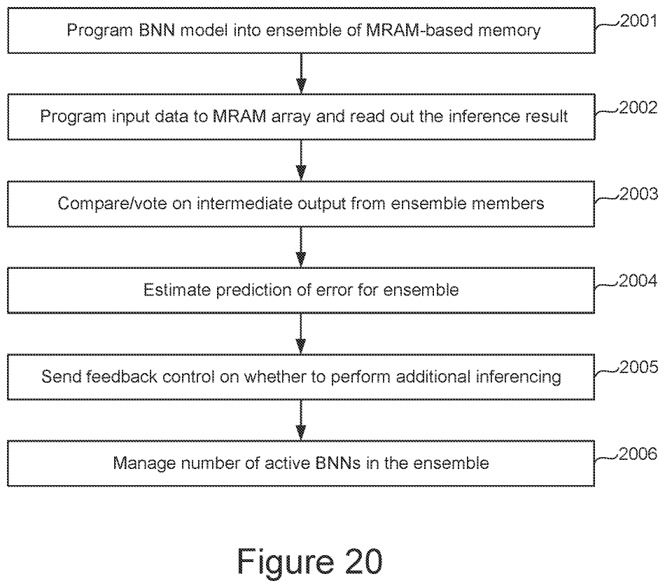

In the embodiment of FIG. 17, a host 1720 is shown connected to a memory controller 1702 that is in turn connected to a memory die 1700, where these elements can be as described above with respect to FIGS. 1-6B. (Arrows 1-5 are discussed below with respect to FIG. 20.) Only one die 1700 is shown, but a memory system can have many such dies, where each die can include a number of arrays (as described with respect to FIG. 13), and each die can be implemented as a bond die pair (as described above with respect FIGS. 6A and 6B). The representation of FIG. 17 (along with those of FIGS. 18 and 19) is simplified for purposes of this discussion.

Memory die 1700 includes a number of MRAM arrays 1702-1, 1702-2, . . . , 1702-N each storing a corresponding binary neural network BNN 1, BNN 2, . . . , BNN N of an ensemble. In response to a set of inputs for a layer or layers of the neural network, each of the arrays 1702-1, 1702-2, . . . , 1702-N generate a corresponding intermediate output Out 1, Out 2, . . . , Out N that will then be combined to generate the final ensemble output. An on-chip buffer can be used to hold both the input data to be applied to the arrays and also the intermediate outputs Out 1, Out 2, . . . , Out N. In the embodiment of FIG. 17, the memory die also includes a voting unit VU 1753 having the logic circuitry to determine the ensemble output from the intermediate outputs Out 1, Out 2, . . . , Out N. In a bonded die pair embodiment, such as discussed above with respect to FIGS. 6A and 6B, the voting unit VU 1753 and also the buffer 1751 can be formed on the control die (i.e., 611) of the pair. The numbered arrows related to the control flow over the bus structures (described with respect to FIGS. 1-6B) connecting the host 1720, controller 1702, and memory die 1700 and will be discussed below with respect to FIG. 20.

The embodiment of FIG. 18 is arranged as FIG. 17, is similarly numbered, and can largely operate as FIG. 17, except now the voting unit VU 1853 is part of the memory controller 1802. The host 1820 can be as in FIG. 17. The memory die 1800 again includes a number of MRAM arrays 1802-1, 1802-2, . . . , 1802-N, each storing a corresponding binary neural network BNN 1, BNN 2, . . . , BNN N of an ensemble, and, in response to a set of inputs for a layer or layers of the neural network, each generating a corresponding intermediate output Out 1, Out 2, . . . , Out N. The buffer 1851 can be on the same memory die as the MRAM arrays or, in a bonded die pair embodiment, be on either the memory die or the control die of the pair.

The embodiment of FIG. 19 is also arranged as FIG. 17, is similarly numbered, and can largely operate as FIG. 17, except now the voting unit VU 1953 is part of the host 1920 and the voting functions can be executed in the processing circuitry of the host, such as a host's CPU or GPU. The host 1920 can be as in FIG. 17, but now also implements the voting unit VU 1953. The memory die 1900 again includes a number of MRAM arrays 1902-1, 1902-2, . . . , 1902-N, each storing a corresponding binary neural network BNN 1, BNN 2, . . . , BNN N of an ensemble, and, in response to a set of inputs for a layer or layers of the neural network, each generating a corresponding intermediate output Out 1, Out 2, . . . , Out N. As before, the buffer 1951 can be on the same memory die as the MRAM arrays or, in a bonded die pair embodiment, be on either the memory die or the control die of the pair.

As illustrated in FIGS. 17-19, the voting unit VU 1753/1853/1953 can be integrated as an in-memory die, on a memory controller, or in a host CPU/GPU embodiment. Generally speaking, these three implementations each successively require more data transfers, but, again successively, allow for greater amounts of processing. The structure allows for a boosting implementation, a bagging implantation, or both, and can be either fixed-point or floating point. The amount of data movement for VU 1853 in the memory controller of embodiment 18 or VU 1953 on a host CPU/GPU of FIG. 19 can be relatively negligible. For instance, in an ensemble system that consists of 10 BNN network and each has 10 outputs (10 classes), then the total amount of transferred data is 10×16×4 or 640 bytes per input. This is very small amount of data compared to the typical bandwidth of a memory interface. (For the embodiment of FIG. 17 where VU 1753 is on the memory die 1700, the outputs of the individual BNNs for not need to be transferred out, only the final data need be read out.)

FIG. 20 is a high level flowchart for an embodiment of a control flow for the embodiments of FIGS. 17-19 and has steps corresponding to the numbered arrows of these figures. Prior to programming a BNN model into the ensemble of arrays 1702-1/1802-1/1902-1, the host 1720/1820/1920 receives or generates a set of weight values as described above with respect to FIG. 15 or 16. These can be the fully trained set of weights to be used for inferencing or, if the compute in memory system is being used for training, a set of weight still in the training process as described with respect to FIG. 10A. The host 1720/1820/1920 transfers the weight values to the memory controller 1702/1802/1902 and these are then programmed into the arrays 1702-1/1802-1/1902-i at step 2001, corresponding to the arrow (1) of FIGS. 17-19. The weight values can be transferred into the buffer 1751/1851/1951, which can correspond to the storage 566/666 of FIG. 5 or 6A or other buffer memory on the memory die 500 or control die 611. The weight values can then be written as binary data into the MRAM or other memory cells technology in a standard programming operation for the technology using the row control circuitry 520/620 and column control circuitry 510/610 under control of the state machine 562/662 and other elements of the system control logic 560/660. As discussed in more detail below, in some embodiments less than all of the weak classifier networks of the ensemble may have their sets of weights programmed into the arrays 1702-i/1802-i/1902-i at step 2001, with additional sets being maintained by the host 1720/1820/1920, the memory controller 1702/1802/1902, or on the memory die 1700/1800/1900 to be subsequently programmed in if a higher level of accuracy is wanted. Also as part of step 2001, the host 1720/1820/1920 can also transfer the error weight αᵢ values to the memory controller 1702/1802/1902, with the error weight αᵢ then stored as register values on the memory device, such as on the controller 1702/1802/1902 or on the memory die 1700/1800/1900. In particular, the αᵢ values can be programmed to the voting unit VU 1753/1853/1953 by the host 120. The αᵢ values could be programmed to the same or different values depending on whether the bagging or boosting method is respectively used in the training phase. Consequently, the inference accelerator architectures presented here can support both models generated by the bagging and boosting methods, where the αᵢ are known prior to inferencing.

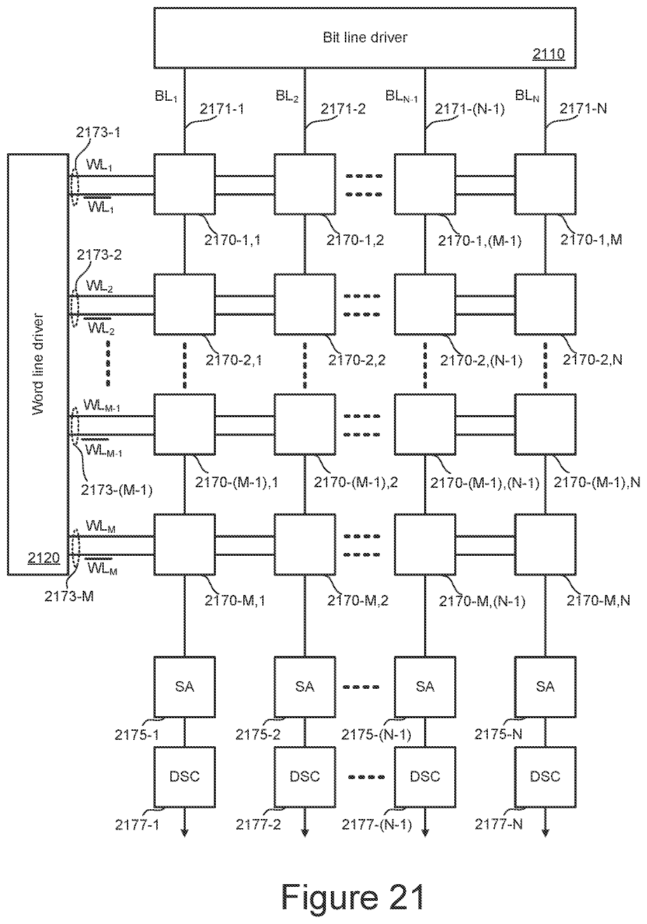

At step 2002, a set of input for the ensemble of BNNs is received from the host 1720/1820/1920 at the controller 1702/1802/1902 and supplied to the ensembles. As described in more detail with respect to FIGS. 21-23, the input values, or activations, are “programmed” by biasing word line pairs. The inferencing operation is similar to a standard read operation and can similarly be performed by the row control circuitry 520/620 and column control circuitry 510/610 under control of the state machine 562/662 and other elements of the system control logic 560/660, but with the word lines biased in pairs. The resultant intermediate outputs Out 1, Out 2, . . . , Out N can then be collected in the buffer 1751/1851/1951, allowing for the host to read out the inferencing result, corresponding to (2) of FIGS. 17-19. The caparison/voting by the voting unit VU 1753/1853/1953 is performed at step 2003 according to the embodiment.

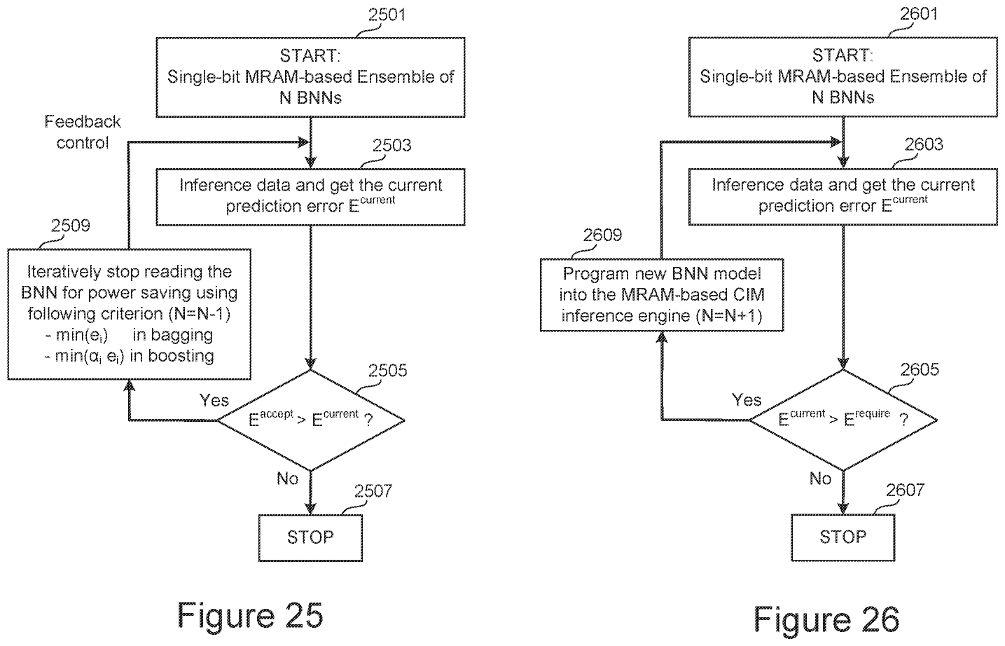

As discussed with respect to FIGS. 25 and 26, in some embodiments the amount of error of the ensemble BNN is estimated to determine whether or not to perform more inferencing. If so, this is done in steps 2004-2006. At step 2004, and corresponding to (3) of FIGS. 17-19 for embodiments where this is performed on the host 1720/1820/1920, the result of the inferencing is transferred and an estimation of the prediction error for the ensemble is generated. At step 2005 this result is used as feedback control, corresponding to (4) in FIGS. 17-19, on whether more inferencing is to be performed. Based on the feedback, at step 2006 and as indicated at (5) the memory controller 1702/1802/1902 can manage the number of active BNNs in the ensemble.

FIGS. 21-23 provide more detail on embodiments of the arrays for the ensemble as single bit MRAM arrays to realize binary valued vector matrix multiplication on a single level MRAM array. In FIGS. 21-23, a unit synapse is formed of a pair of memory cells on a shared bit line. Due to their reliability and low cost, single-bit MRAM memory cells are well suited for such an application. Although the embodiments described here focus on an MRAM based technology, other memory technologies (e.g., ReRAM, PCM, FRAM, and other programmable resistance memory cells) can also be used.

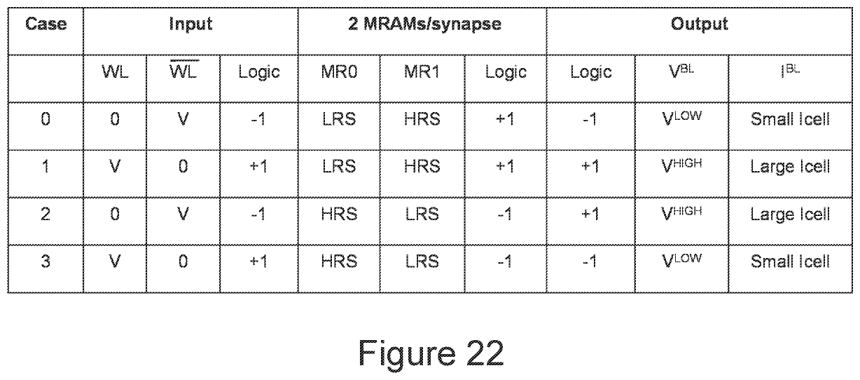

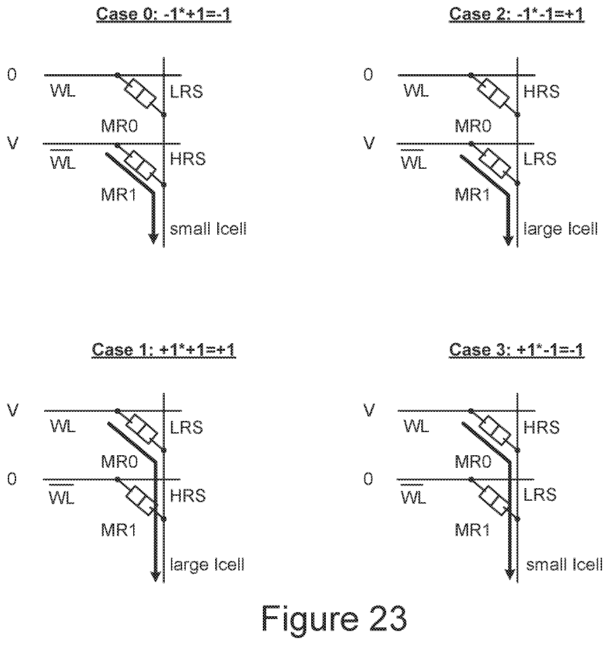

FIG. 21 illustrates an array of unit synapses 2170-i,j connected along N bit lines BLj 2171-j and M word line pairs WL/WLbar-i 2173-i. A bit line driver 2110 is connected to bias the bit lines and a word line driver 2120 is connected to bias the word line pairs. In FIG. 21, the two word lines of a word line pair WL/WLbar-i 2173-i are shown to be adjacent, but need not be so in an actual implementation. As discussed with respect to FIGS. 22 and 23, the word lines WL and WLbar are biased oppositely, so that the word lines can be decoded separately or as a pair, with the one value being generated from the other by an inverter.

In an inferencing operation, the word line pairs can be “programmed” (biased) by the word line driver 2120 with the input values sequentially, with the bit line driver 2110 activating multiple bit lines concurrently to be read out in parallel. By using a binary embodiment and activating only a single word line pair at a time, digital-to-analog and analog-to-digital converters are not needed and simple, single bit sense amplifiers SA 2175-j can be used, with a digital summation circuit DSC 2177-j accumulating the results by counting the “1” results as the word line pairs are sequentially read. This structure provides for high parallelism across the bit line and array level, while still using relatively simple circuitry. Alternate embodiments can activate multiple word line pairs currently, although this would use multi-bit sensing along the word lines.

FIG. 22 is a truth table for the implementation of a synapse as a pair of MRAM memory cells and FIG. 23 is a schematic of the bias levels applied to the memory cells and the resultant current levels. For a binary implementation, both the inputs and weights have logic values of −1 or +1. The four combinations are cases 0, 1, 2, and 3 as illustrated in the table of FIG. 22. When the input value and weight value match, the output logic is +1, and when the input value and weight value do not match, the output logic is −1.

As illustrated in FIG. 23, one synapse is formed of two single-bit MRAM memory cells, MR0 and MR1, connected between respective word line WL and word line WLbar and a common bit line BL. The binary MRAM memory cells have a high resistance state HRS and a low resistance state LRS, where a +1 logic state is encoded as MR0 programmed to LRS and MR1 programmed to HRS and a −1 logic state is encoded as MR0 programmed to HRS and MR1 programmed to LRS. The input values are encoded to the word line pairs as complementary voltages, with a +1 logic state corresponding to WL at a higher voltage level V and WLbar at a lower voltage (e.g., 0V), and a −1 logic state corresponding WL at the lower voltage (0V) and WLbar at the higher voltage level V. In cases 0 and 3, where the input logic and weight value do not match, the higher voltage is applied to the HRS memory cell and the lower voltage is applied to the LRS memory cell, resulting only in small Icell for the bit line current I^{BL} and a low bit line voltage V^{BL}=V^{LOW}, corresponding to an output logic value of −1. In cases 1 and 2, the input logic and the synapse's logic match (both +1 and both −1, respectively) so that the higher voltage level V is applied to the LRS memory cell, resulting in +1 output logic of I^{BL}=large Icell and V^{BL}=V^{HIGH}.

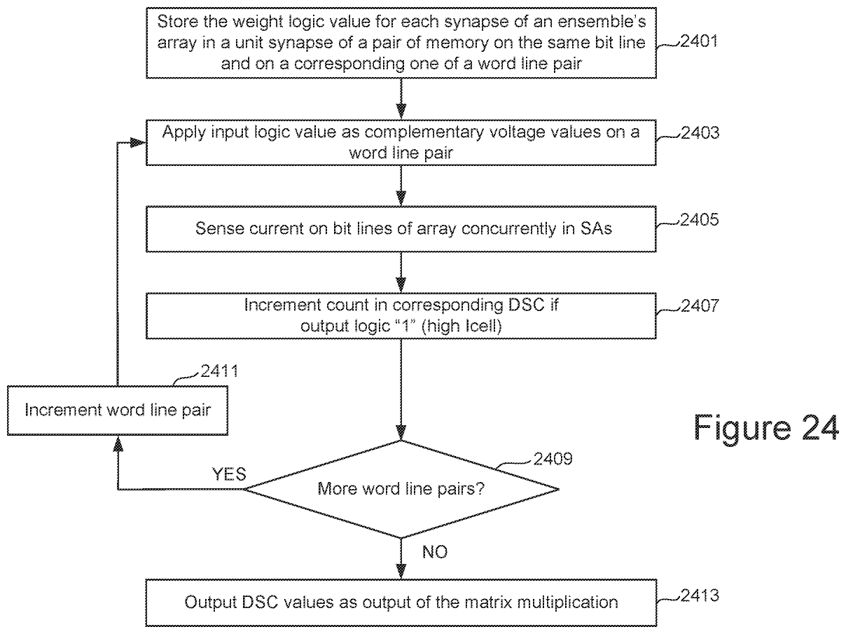

FIG. 24 is a flowchart for an embodiment of performing an inference operation based on the structures illustrated in FIGS. 21-23, providing additional detail for steps 2001 and 2201 of FIG. 20 in the context of FIGS. 21-23 for a single array of an ensemble. Beginning at step 2401, the weight logic value for each synapse of the array is programmed into a unit synapse 2170-i,j of a pair of binary valued MRAM memory cells (MR0, MR1) along a shared bit line BLj 2171-j and a corresponding one of a word line pair 2173-i.

Once the synapses are programmed, the input logic values can be applied by the word line driver 2120 to a first word line pair as complementary voltage values at step 2403. The resultant currents, corresponding to the output logic values, in the bit lines of the array are sensed concurrently by the sense amplifiers SA 2175-j at step 2405. In step 2407, the DSC 2177-j increments the count if the output logic from SA 2175-j is a “1” (high Icell). Step 2409 determines whether there are more word line pairs that need to be computed in the matrix multiplication and, if so, increments the word line pair at step 2411 and goes back to step 2403; if not, the DSC values are output as the result of the matrix multiplication (the intermediate output Out for the array of the ensemble) at step 2413.

FIG. 25 is a flowchart of an embodiment for optimizing power consumption during inferencing operations by utilizing ensemble binary neural networks that apply adaptive power control. As described above with respect to FIGS. 15 and 16, when training an ensemble neural network, an error prediction can be generated. One case where adaptive power control can be applied is when the acceptable amount of prediction error of the ensemble binary neural network is significantly larger than the initial amount of error. In this case, power consumption can be optimized by increasing the current amount of error, E^{current}, to be increased as close to the acceptable amount of error, E^{accept}, as can be done without exceeding this value, thereby reducing the effective size of the ensemble for power saving. Another example of where power consumption can be optimized is when the system is operating in power-limited condition: By applying the flow of FIG. 25, both E^{accept} and E^{current} are first adjusted to meet the power requirement.

The power optimization flow starts at 2501, with operating of an ensemble of N single-bit MRAM based neural networks escribed with respect to FIGS. 17-24. At step 2503 the inferencing data is generated for each of the arrays of the ensemble as described with respect to FIGS. 21-24 and a prediction of current error for the ensemble is determined for the N individual errors as

$$Bagging {E}^{currrent} = \frac{1}{N} {\sum }_{1}^{N} {e}_{i}$$

for a bagging embodiment or as

$$Boosting {E}^{currrent} = \frac{1}{N} {\sum }_{1}^{N} {α}_{i} {e}_{i}$$

for a boosting embodiment.

At step 2505, the current amount of predicted error E^{current} is compared to the acceptable prediction error threshold value E^{accept}, which can a be pre-determined amount depending on the application to which the neural network is being applied. If the E^{current} value exceeds E^{accept}, then the process stops at 2507. If, instead, the amount of predicted error E^{current} is lower than the acceptable amount, then the inferencing can be done with fewer arrays in the ensemble than the full set of N arrays. In this case, at step 2509, the system can iteratively stop reading the neural networks for power saving, taking N to N−1 for the number of arrays read, using the criteria of the minimum eᵢ value in a bagging embodiment and the minimum (αᵢ eᵢ) in a boosting embodiment, and looping back to step 2503. This provides feedback control to iteratively reduce the number arrays from the ensemble until the E^{current} approaches the acceptable level. Without loss of generality, the power saving factor by taking away one the BNN of ensemble of BNNs is 1/N, in where N is the total number of BNN before adaptive control.

FIG. 26 is a flowchart of an embodiment for reinforcing an ensemble binary neural network's accuracy by adding binary neural networks to the ensemble. This technique can improve the prediction error of the ensemble binary neural network in order to provide accuracy comparable to a full-precision DNN by bring in more BNNs into the ensemble. To implement this method, the voting unit (VU 1753/1853/1953) is configured so that it can be programmable to handle more inputs coming from the additional BNNs.

The flow of FIG. 26 starts at 2601 with the ensemble configured to have N single-bit MRAM based BNNs. Similarly to step 2503 of FIG. 25, at step 2603 the inferencing data is generated for each of the arrays of the ensemble as described with respect to FIGS. 21-24 and a prediction of current error for the ensemble is determined for the N individual errors as

$$Bagging {E}^{currrent} = \frac{1}{N} {\sum }_{1}^{N} {e}_{i}$$

for a bagging embodiment or as

$$Boosting {E}^{currrent} = \frac{1}{N} {\sum }_{1}^{N} {α}_{i} {e}_{i}$$

for a boosting embodiment.

Step 2605 compares the current amount of predicted error E^{current} to an error requirement threshold value E^{require} of a maximum amount of error. If the current predicted error E^{current} is within the requirement (E^{current}<E^{require}), the flow goes to 2607 and stops. If the current amount of predicted error is above the limit, the flow instead goes to step 2609 and adds arrays to the ensemble before looping back to step 2603. At step 2609, a new DNN model is programmed into the memory device, such as by increasing the size of the ensemble from N to N+1, where this can be determined by a host 120 or memory controller 102, for example. In some embodiments, the model of additional BNNs can have been determined as part of the initial training process and be stored in the host or in non-volatile memory of the memory system as pre-trained models, so as to avoid a re-training requirement. Alternately, a re-training can be performed to generate the model for additional BNNs. Without loss of generality, the power overhead by adding an extra BNN to the ensemble is 1/N, in where N is the total number of BNNs before reinforcement.

The embodiments described here provide efficient architectures that utilize single-bit MRAM memory arrays for compute-in-memory (CIM) inference engine to achieve low prediction error that is comparable to multi-bit precision CIMs of deep network architectures and large data sets. The leveraging of simple and efficient BNN networks for single-level MRAM-based CIM inference engines reduce the overhead of expensive peripheral circuits. The ability to reduce and increase the ensemble size respectively allows dynamic optimization of power consumption and reinforcement of prediction accuracy of the single-level MRAM-based ensemble BNN inference engine.

According to a first set of aspects, a non-volatile memory device includes a control circuit configured to connect to a plurality of arrays of non-volatile memory cells each storing a set of weight values of one of a plurality of weight matrices each corresponding to one of an ensemble of neural networks. The control circuit is configured to: receive a set of input values for a layer of the ensemble of neural networks; convert the set of input values to a corresponding set of voltage levels; perform an in memory multiplication of the input values and the weight values of the weight matrices of the corresponding ensemble of neural networks by applying set of voltage levels to the arrays of non-volatile memory cells; perform a comparison of results of the in memory multiplications of the ensemble of neural networks; and, based on the comparison, determine an output for the layer of the ensemble of neural networks.

In additional aspects, a method includes: receiving, at a non-volatile memory device, a set of input values for a layer of an ensemble of a plurality of neural networks, weight values for the layer of each of the neural networks of the ensemble being stored in a corresponding array of the non-volatile memory device; and performing an in memory multiplication of the input values and the weight values for the ensemble of neural networks. The in memory multiplication is performed by: converting the set of input values to a corresponding set of voltage levels, applying the set of voltage levels to the corresponding arrays, and determining an intermediate output for each of the neural networks of the ensemble based on current levels in the corresponding array in response to the set of voltage levels. The method also includes: determining an output for the layer of the ensemble based on a comparison of the intermediate outputs; determining an amount of error for the output for the layer of the ensemble; comparing the amount of error to an error threshold value; and, based on comparing the amount of error to the error threshold value, determining whether to change the number of neural networks in the ensemble.

In another set of aspects, a non-volatile memory device includes a plurality of non-volatile memory arrays and one or more control circuits connected to the plurality of non-volatile memory arrays. Each of the arrays includes a plurality of binary valued MRAM memory cells connected along bit lines and word lines, and each of the arrays configured to store weights of a corresponding one of an ensemble of binary valued neural networks, each weight value stored in a pair of MRAM memory cells connected along a common bit line and each connected to one of a corresponding pair of word lines. The one or more control circuits are configured to: receive a plurality of inputs for a layer of the ensemble of binary valued neural networks; convert the plurality of inputs into a plurality of voltage value pairs, each pair of voltage values corresponding one of the inputs; apply each of the voltage value pairs to one of the word line pairs of each of the arrays; determine an output for each of binary valued neural networks in response to applying the voltage value pairs to the corresponding array; and determining an output for the ensemble from a comparison of the outputs of the binary valued neural networks.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. A non-volatile memory device, comprising:
a control circuit configured to connect to a plurality of arrays of non-volatile memory cells each storing a set of weight values of one of a plurality of weight matrices each corresponding to one of an ensemble of neural networks, the control circuit configured to:
receive a set of input values for a layer of the ensemble of neural networks;
convert the set of input values to a corresponding set of voltage levels;
perform an in memory multiplication of the input values and the weight values of the weight matrices of the corresponding ensemble of neural networks by applying set of voltage levels to the arrays of non-volatile memory cells;
perform a comparison of results of the in memory multiplications of the ensemble of neural networks; and
based on the comparison, determine an output for the layer of the ensemble of neural networks.

2. The non-volatile memory device of claim 1, wherein the control circuit is formed on a control die, the non-volatile memory device further comprising:
a memory die including one of more of the arrays of non-volatile memory cells, the memory die formed separately from and bonded to the control die.

3. The non-volatile memory device of claim 2, wherein the memory cells are binary MRAM cells, each of the weight values stored in a pair of memory cells connected to a shared bit line.

4. The non-volatile memory device of claim 1, the control die including logic circuitry configured to perform the comparison of the results of the in memory multiplications of the ensemble of neural networks.

5. The non-volatile memory device of claim 1, wherein the control circuit is configured to perform the comparison of the results of the in memory multiplications of the ensemble of neural networks by performing a majority vote operation between the results of the in-memory multiplications.

6. The non-volatile memory device of claim 1, wherein the non-volatile memory device includes a memory controller comprising a portion of the control circuit configured to the comparison of the results of the in memory multiplications of the ensemble of neural networks.

7. The non-volatile memory device of claim 1, wherein the control circuit is configured to perform the comparison of the results of the in memory multiplications of the ensemble of neural networks by transferring the results of the in memory multiplications of the ensemble of neural networks to a host connected to the non-volatile memory device.

8. The non-volatile memory device of claim 1, wherein the memory cells of each of the arrays are binary valued memory cells having a high resistance state and a low resistance state and are connected along bit lines and word lines, each of the weight values are stored in a pair memory cells connected along a shared bit line and each connected to one of a corresponding word line pair, and wherein each of the corresponding sets of voltage levels is a pair of voltage levels and the control circuit is configured to:
perform the in memory multiplication of the input values and the weight values of the weight matrices of the corresponding ensemble of neural networks by applying the pairs of voltages to the word pairs of the arrays and determine resultant current levels on the bit lines of the arrays.

9. The non-volatile memory device of claim 1, wherein the control circuit is further configured to:
determine an amount of error for the output for the layer of the ensemble of neural networks;
compare the amount of error to an error threshold value; and
based on comparing the amount of error to an error threshold value, determine whether to change a size of the ensemble used to determine the output for the layer of the ensemble of neural networks.

10. The non-volatile memory device of claim 9, wherein the amount of error is an average of the error from individual neural networks of the ensemble.

11. The non-volatile memory device of claim 9, wherein the amount of error is a weighted average of the error from individual neural networks of the ensemble.

12. The non-volatile memory device of claim 9, wherein the control circuit is configured to:
compare the amount of error to the error threshold value by determining whether the among of error is below the threshold value; and
in response to the amount of error being less than the threshold value, reduce the size of the ensemble used to determine the output for the layer of the ensemble of neural networks.

13. The non-volatile memory device of claim 9, wherein the control circuit is configured to:
compare the amount of error to the error threshold value by determining whether the among of error is above the threshold value; and
in response to the amount of error being less than the threshold value, increase the size of the ensemble used to determine the output for the layer of the ensemble of neural networks.

14. A method, comprising:
receiving, at a non-volatile memory device, a set of input values for a layer of an ensemble of a plurality of neural networks, weight values for the layer of each of the neural networks of the ensemble being stored in a corresponding array of the non-volatile memory device;
performing an in memory multiplication of the input values and the weight values for the ensemble of neural networks by:
converting the set of input values to a corresponding set of voltage levels,
applying the set of voltage levels to the corresponding arrays, and
determining an intermediate output for each of the neural networks of the ensemble based on current levels in the corresponding array in response to the set of voltage levels,
determining an output for the layer of the ensemble based on a comparison of the intermediate outputs;
determining an amount of error for the output for the layer of the ensemble;
comparing the amount of error to an error threshold value; and
based on comparing the amount of error to the error threshold value, determining whether to change a number of neural networks in the ensemble.

15. The method of claim 14 wherein:
comparing the amount of error to an error threshold value includes determining whether the among of error is below the threshold value; and
determining whether to change the number of neural networks in the ensemble includes reducing the number of neural networks in the ensemble in response to the amount of error being less than the threshold value.

16. The method of claim 14, wherein:
comparing the amount of error to an error threshold value includes determining whether the among of error is above the threshold value; and
determining whether to change the number of neural networks in the ensemble includes increasing the number of neural networks in the ensemble in response to the amount of error being less than the threshold value.

17. The method of claim 14, further comprising:
prior to receiving the set of input values for the layer of the ensemble, determining the weight values for the layer of each of the neural networks of the ensemble from a corresponding dataset, each of the corresponding datasets being a subset of a larger training dataset; and
programming the weight values for the layer of each of the neural networks of the ensemble into the corresponding array of the non-volatile memory device.

18. The method of claim 17, wherein, for a first neural network of the ensemble and a second neural network of the ensemble, determining the weight values for the layer of each of the neural networks of the ensemble includes:
determining the weight values for the layer of the first neural network of the ensemble from the corresponding dataset;
subsequent to determining the weight values for the layer of the first neural network of the ensemble, updating the dataset corresponding to the second neural network of the ensemble based on the weight values for the layer of the first neural network of the ensemble; and
determining the weight values for the layer of the second neural network of the ensemble from the updated corresponding dataset.

19. A non-volatile memory device, comprising:
a plurality of non-volatile memory arrays, each of the arrays including a plurality of binary valued MRAM memory cells connected along bit lines and word lines, and each of the arrays configured to store weights of a corresponding one of an ensemble of binary valued neural networks, each weight value stored in a pair of MRAM memory cells connected along a common bit line and each connected to one of a corresponding pair of word lines; and
one or more control circuits connected to the plurality of non-volatile memory arrays and configured to:
receive a plurality of inputs for a layer of the ensemble of binary valued neural networks;
convert the plurality of inputs into a plurality of voltage value pairs, each pair of voltage values corresponding one of the inputs;
apply each of the voltage value pairs to one of the word line pairs of each of the arrays;
determine an output for each of binary valued neural networks in response to applying the voltage value pairs to a corresponding array; and
determining an output for the ensemble from a comparison of the outputs of the binary valued neural networks.

20. The non-volatile memory device of claim 19, wherein the one or more control circuits connected are further configured to:
determine an amount of error for the output for the ensemble;
compare the amount of error to a threshold value; and
determine whether to change a number of binary valued neural networks in the ensemble based on comparing the amount of error to the threshold value.
